(19) United States
(12) Patent Application Publication
(10) Pub. No.: US 2022/0335484 A1
(43) Pub. Date: Oct. 20, 2022

(54) QUANTITATIVE ASSET VALUATION AND DISPOSITION SYSTEM

(71) Applicant: Vintell Analytics, LLC, Manheim, PA (US)

(72) Inventors: Keith W. McCord, Florissant, MO (US); Robert M. Hollenshead, Delray Beach, FL (US); Jeffrey J. Zamora, Lake Arrowhead, CA (US); Michael A. Hamilton, Saint Charles, MO (US); Anthony W. Bradley, Golden Eagle, IL (US)

(21) Appl. No.: 17/668,111

(22) Filed: Feb. 9, 2022

Related U.S. Application Data
(60) Provisional application No. 63/149,731, filed on Feb. 16, 2021.

(51) Int. Cl. G06Q 30/02; G07C 5/00; G07C 5/08

(52) U.S. Cl. CPC G06Q 30/0283; G07C 5/008; G07C 5/0816

(57) ABSTRACT

A data collection device may communicate with one or more onboard systems of a first vehicle. The data collection device may receive payload data from the one or more onboard systems that indicate one or more faults with the one or more onboard systems. An analysis controller that may obtain the payload data from the data collection device, compare the payload data from the data collection device with other payload data obtained from other vehicles, and calculate a valuation of the first vehicle based on the payload data and comparing the payload data with the other payload data.

### CROSS-REFERENCE TO RELATED APPLICATIONS

This application claims priority to U.S. Provisional Application No. 63/149,731 (filed 16 Feb. 2021), the entire disclosure of which is incorporated herein by reference.

### BACKGROUND

### Technical Field

The subject matter described herein relates to unique hardware, algorithms, and business processes for generating appraisal values for vehicles (e.g., automobiles, trucks, motorcycles, etc.).

### Discussion of Art

Some known methods for vehicle appraisals to determine valuation have been in place for decades. Unfortunately, there may be only one time in a vehicle's lifecycle that the valuation is known, and that may include when the vehicle leaves the assembly line and is delivered to the dealership as a new vehicle. The vehicle lifecycle may be the series of stages that a vehicle transitions through during existence of the vehicle. These stages may include a new stage, a retail sale of a new vehicle, a first owner of the vehicle stage, usage stage (where the vehicle is used on a regular basis), retail used sale stage where the vehicle is sold as a used vehicle, one or more additional owner stages where the vehicle is owned by one or more other owners, an additional usage stage where the vehicle is used by the other owners, and a recycle stage. The recycle stage can be the final stage of the life of the vehicle where the value in removing the parts of the vehicle and selling the parts individually may be more valuable than the vehicle itself (also known as a parting the car out). Businesses known as recycling centers, junk yards, salvage yards, or scrap yards may recycle vehicles.

At the time that the vehicle is delivered to a dealership as a new vehicle, the valuation has a range between the retail manufacturer suggested retail price (MSRP) and the dealer's invoice (e.g., quantitative valuation). A target retail price may be the price of a vehicle at a retail dealership lot or the price of a vehicle that is transferred between consumers (e.g., not dealer-to-consumer or consumer-to-dealer) or that is transferred between dealers. As the vehicle proceeds through its lifecycle, the condition of the vehicle changes, the mileage of the vehicle increases, and the market demand for the vehicle can shift, and all the while the subjective valuation (e.g., qualitative valuation) of the vehicle can vary significantly especially across different use cases. In today's use cases, with different use case processes, it may be difficult or impossible to shift from a quantitative valuation to a qualitative valuation and return to a quantitative valuation.

The process for evaluating a buyer's vehicle purchase decision typically involves trying to derive a meaningful valuation of that vehicle. The basis for partially deriving that vehicle value may be gained from gathering services known as valuation books (e.g., Galves Market Data™, NADA Guide™, Black Book®, Kelly Blue Book® and various sources of transactional market reports). The valuation books can provide a range of values based on clusters of vehicles divided by the year, make, and model of the vehicles (e.g., YMM) and a general overall condition. The year can represent the year the vehicle was made or manufactured, the make can refer to the original equipment manufacturer (OEM) that produced the vehicle, and the model can refer to the commercial model of the vehicle (as established by the OEM). The combination of the year, make, and model of a vehicle can be referred to as YMM. But the valuations provided by these books may not be based on VIN-specific optional upgrades (e.g., optional equipment added to the vehicle at or after the initial purchase).

The vehicle value derived by an appraisal using the valuation books may primarily be based off qualitative data sets which is built upon non-standardized, subjective, and process-oriented data approach. To truly derive an accurate, repeatable valuation for appraisals, the measuring data sets may need to be quantitative, non-parametric driven outcome oriented.

Furthermore, the valuations derived for the vehicles using valuation books are also employed by other business segments that may require a valuation of the vehicle. For example, banks may require an accurate valuation as to determine the asset's collateralized value to loan against. Insurance companies and banks may require asset valuation guidance when understanding how much to underwrite the vehicle. The derived valuation may impact many aspects of the industry aside from a simple question of “how much is the car worth.” For example, the insurance companies and banks may need to fully understand how the current condition of a vehicle and whether the vehicle has been repaired and/or maintained safely and properly impacts the value of the vehicle. This information can significantly impact the value of the vehicle, as well as raise liability issues and decisions involved in deciding whether to write a vehicle off as a total loss or a repair (in the event of an accident).

Unfortunately, using conventional valuation methods, much of the basis for valuation is based on a wide range of values that can vary by as much as 40% and may be commonly biased on the subjective physical appearance of that vehicle. Furthermore, with no consistency between the variety of valuation books and standards, the ranges of valuations can vary greatly (see below at Table 1: Book Valuations vs Potential Profit). Combining this lack of consistency with different appraiser techniques, local market trends, and the lack of ability to differentiate unique vehicle identification number (VIN) characteristics, vehicle valuations can vary even more. The VIN can refer to a vehicle identification number, such as a unique 17-digit identification number or serial number that identifies a specific vehicle. Alternatively, another unique vehicle identifier can be used. An example of this is the potential profit from remarketing a vehicle that can be vastly affected by which valuation book is used and the appraiser's skill and disposition. This also affects consumer confidence as the derived valuation book values may have no scientific facts to justify the valuations and can be viewed as completely subjective and possibly punitive.

TABLE 1
Book Valuations vs Potential Profit

| Vehicle | Trade-In | Book | Potential |
|---|---|---|---|
| Exhibit “A” | Value | Retail Value | Profit |
| Book #1 | $34,350 | $37,600 | $3,250 |
| Book #2 | $36,625 | $37,600 | $975 |
| Book #3 | $33,374 | $37,600 | $4,226 |

### Source: Kelly Blue Book, Black Book, NADA Guide

Compounding the valuation difference between valuation books, the subjective physical evaluation of the vehicle by the appraiser will also dramatically affect the appraisal (see below at Table 2: Condition Factors in Vehicle Appraisal). Under this scenario, the definitions of, in this case, clean/average/rough (e.g., qualitative measurements) are so vague that subjective interpretation can be liberally applied to skew the value to gain an advantage. Furthermore, this physical evaluation rarely examines the vehicle's mechanical condition, which on average could affect the valuation more than vehicle's cosmetic (body or interior) condition. The lack of physical access to the vehicle exacerbates the valuation inaccuracies for companies such as banks, warranty companies, insurance underwriters, etc. as they are wholly reliant on a generic range of values based on YMM from the valuation books. Additionally, missing equipment of a vehicle can result in the valuation being too high. For example, some vehicles that are sold as having standard equipment for the YMM, engine, and trim level of the vehicle. But due to various circumstances (e.g., shortages of equipment such as computer processors), some vehicles may be sold without the standard equipment. The current valuations of vehicles may be based on an assumption that all standard equipment is present in the vehicle when the equipment may actually be missing (or substituted with inferior replacement equipment).

TABLE 2
Condition Factors in Vehicle Appraisal

| Vehicle Trade-In | Clean | Average | Rough |
|---|---|---|---|
| Vehicle Exhibit “B” | $12,635 | $11,805 | $9,585 |
| Vehicle Exhibit “C” | $14,615 | $13,415 | $10,655 |

### Source: Consumer Reports, Black Book

To date, there has not been a method or system that can scientifically derive, with repeatability and accuracy, the value of a vehicle through an appraisal process. This completely subjective valuation may attempt to use a bell curve statistical methodology to group a particular YMM cluster of valuations. Unfortunately, this method does not consider the uniqueness of each VIN in terms of valuation due to physical and mechanical conditions as well as historical pedigree of the vehicle based on multiple appraisal points throughout the lifecycle of the VIN.

### BRIEF DESCRIPTION

In one example, a system includes a data collection device that may communicate with one or more onboard systems of a first vehicle. The data collection device may receive payload data from the one or more onboard systems that indicate one or more faults with the one or more onboard systems. The system also may include an analysis controller that may obtain the payload data from the data collection device, compare the payload data from the data collection device with other payload data obtained from other vehicles, and calculate a valuation of the first vehicle based on the payload data and comparing the payload data with the other payload data.

In another example, a method includes communicating with one or more onboard systems of a first vehicle to receive payload data from the one or more onboard systems. The payload data may indicate one or more faults with the one or more onboard systems. The method also may include comparing the payload data from the data collection device with other payload data obtained from other vehicles and calculating a valuation of the first vehicle based on the payload data and comparing the payload data with the other payload data.

In another example, another system may include a data collection device that may communicate with one or more onboard systems of a first vehicle. The data collection device may receive payload data from the one or more onboard systems that indicate one or more faults with the one or more onboard systems. The system also may include an analysis controller that may obtain the payload data from the data collection device, extract one or more markers from the dynamic payload data indicative of at least one latent fault of the one or more onboard systems, compare the payload data from the data collection device with other payload data obtained from other vehicles, and calculate a valuation of the first vehicle based on the payload data and comparing the payload data with the other payload data using a longitudinal cohort analysis.

### BRIEF DESCRIPTION OF THE DRAWINGS

A clear understanding of the features of the inventive subject matter summarized above may be had by reference to the appended drawings, which illustrate the method and system of the inventive subject matter, although it will be understood that such drawings depict one or more embodiments of the inventive subject matter and, therefore, are not to be considered as limiting its scope with regard to other embodiments of the inventive subject matter. Accordingly:

FIG. 1 illustrates one example of a quantitative valuation and disposition system;

FIG. 2 illustrates one example of a data collection device shown in FIG. 1;

FIG. 3 illustrates a flowchart of one example of a method for valuating an asset;

FIG. 4 illustrates another example of the valuation system;

FIG. 5 illustrates another diagram of the valuation system extracting pertinent vehicle identification, status, and diagnostics according to one example;

FIG. 6 illustrates a diagram of operation of the valuation system in performing a longitudinal cohort analysis;

FIG. 7 illustrates a diagram of operation of the valuation system performing longitudinal retrospective analysis and effects of VIN-specific valuations;

FIG. 8 illustrates operation of the valuation system with respect to the weighting valuation modeler for VIN-specific valuations;

FIG. 9 illustrates operation of the valuation system with respect to with respect to the weighting valuation modeler for VIN-specific valuations;

FIG. 10 illustrates a diagram of operation of the valuation system to determine an aftermarket warranty valuation of a vehicle;

FIG. 11 illustrates operation of the valuation system to gain insight during the disposition decision paths available when evaluating acquiring a vehicle 110 from the wholesale automotive environment;

FIG. 12 illustrates operation of the valuation system to gain insight during the disposition decision paths available when underwriting a warranty policy for a vehicle in a retail automotive environment;

FIG. 13 illustrates operation of the valuation system to gain insight during the disposition decision paths available when evaluating to acquire a vehicle through an automotive service lane environment;

FIG. 14 illustrates operation of the valuation system to gain insight during the lending decision paths available when evaluating whether to extend credit or a loan on a specific VIN of a vehicle via a lending decision path;

FIG. 15 illustrates operation of the valuation system to gain insight during the consumer's disposition and purchase decision paths available on a specific VIN of a vehicle;

FIGS. 16A and 16B illustrate one example of an output report that can be generated by the valuation system described herein; and

FIG. 17 illustrates operation of the valuation system to monitor trends across valuations of many vehicles.

### DETAILED DESCRIPTION

The subject matter described herein relates to unique hardware, algorithms, and business processes for generating a specific, scientifically derived, valuation for a unique VIN or other identifying information of a vehicle. One or more embodiments of the systems and methods described herein can extract diagnostic and status information from a vehicle and analyze and decode the extracted information. The extracted and decoded information can be gathered and mapped to an algorithmically derived vehicle valuation. The systems and methods may be used in connection with industries that use or rely on vehicle appraisals during the vehicle's lifecycle including, but not limited to, retail and wholesale automotive sales, banks, insurance underwriters and residual value appraisers, repair facilities, and warranty companies.

Additionally, industries requiring longitudinal cohort analysis of vehicle fleets including original equipment manufacturers, quality studies, such as the Environmental Protection Agency (EPA), National Auto Auction Association (NAAA), and the National Highway Traffic Safety Administration (NHTSA), insurance companies, and the like. Several decision paths or choices are described herein. These are potential ways for a seller or buyer to acquire (e.g., purchase) or dispose (e.g., sell) a vehicle using the valuation provided by the systems and methods described herein. The systems and methods can collect data about a first vehicle, compare this data against the same or similar data of other similar vehicles, determine a valuation of the first vehicle based on this comparison, and provide a valuation of the first vehicle to one or more parties involved in the transaction. In one embodiment, the systems and methods may perform one or more tangible acts in response to the valuation being generated, such as moving the evaluated vehicle from one location to another (e.g., from a seller location to a buyer location) by controlling or directing control of a truck or other system to move the vehicle responsive to the valuation being generated, acquiring and repairing one or more onboard systems of the first vehicle responsive to the valuation being improved by such a repair, etc. These actions may be performed by one or more additional systems (e.g., robotic systems) that can receive instructions from the valuation systems and methods described herein to perform the responsive actions.

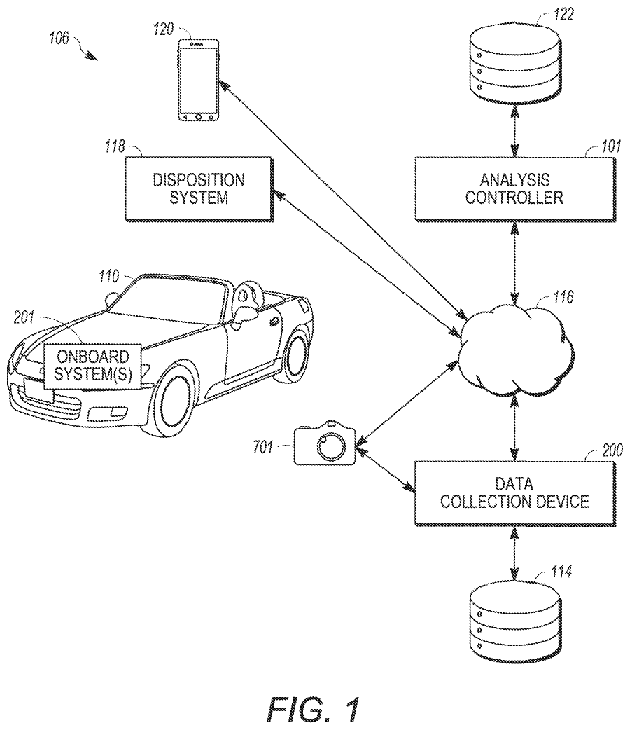

FIG. 1 illustrates one example of a quantitative valuation and disposition system 106. The valuation system 106 can determine a valuation of an asset such as a vehicle throughout the lifecycle or lifespan of the asset and across multiple use cases. The valuation system 106 can establish the process for deriving the standard for use case VIN-specific vehicle valuations through the use of novel hardware, algorithms, and big data analysis. The valuation processes can be redefined to include the electronically accessed status and diagnostics of onboard systems 201 of an asset 110 (e.g., a vehicle) and the physical condition of the vehicle mapping to the VIN-specific valuation. Combining these conditions with internal valuation mappings from scientific, statistical, and mathematical derived algorithms and big data collection, the valuation system 106 can be used to develop accurate, repeatable, transactable VIN-specific valuations focusing on specific markets. These novel methods and systems described herein may eliminate or reduce the subjective or qualitative nature of current valuation methods allowing any skillset to derive accurate, VIN-specific valuation.

The methods and systems provide a novel approach to gathering diagnostic, emissions, equipment configuration, and status information (e.g., vehicle information) directly from the vehicle 110 being valued. The unique method of gathering this vehicle information begins through the use of the novel hardware and/or by accessing other telemetry gathering devices that are temporarily or permanently installed on the vehicle. The valuation system 106 includes a data collection device 200 that may interface or otherwise communicate with one or more onboard systems 201 of the vehicle 110. The data collection device 200 can represent hardware circuitry that includes and/or is connected with one or more processors (e.g., field programmable gate arrays, integrated circuits, microprocessors, etc.) that perform the operations described herein in connection with the data collection device 200. The onboard systems 201 can include or represent an powertrain control unit, electronic control unit, supplemental safety equipment, advanced driver assistance systems, an infotainment system, a crash reporting black box device, one or more sensors (e.g., cameras, radar, microphones, etc.), one or more tangible and non-transitory computer readable storage media (e.g., computer memories), one or more onboard computers of the vehicle, etc.

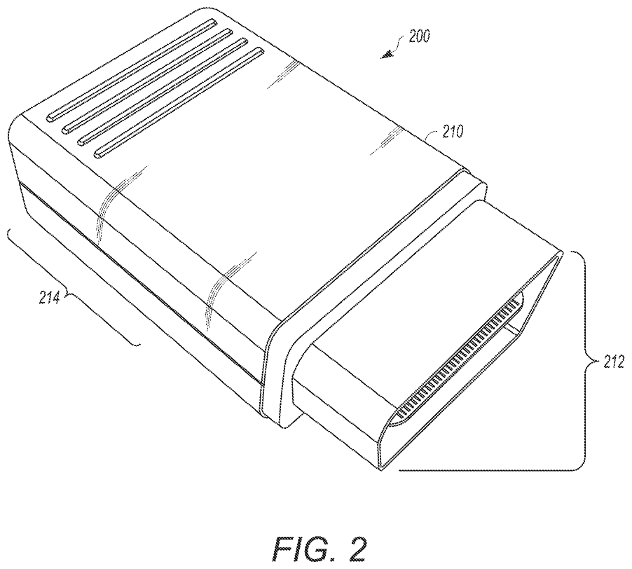

With continued reference to the valuation system 106 shown in FIG. 1, FIG. 2 illustrates one example of the data collection device 200. The data collection device 200 can include an outer housing 210 that includes a connector 212 shaped to mate with the onboard diagnostic port (e.g., the OBD-II/SAE J1962 connector) or another connector of the vehicle 110 to obtain data from the onboard systems 201 of the vehicle 110. The data collection device 200 can include wireless transceiving circuitry 214 within the housing 210 (e.g., one or more antennas, modems, transceivers, etc.) that wirelessly communicate data obtained from the vehicle 110 with one or more other components described herein (e.g., an analysis controller 101 described in connection with FIG. 1). Optionally, the wireless transceiving circuitry 204 of the data collection device 200 can communicate with the onboard systems 201 of the vehicle 110 to collect data from the onboard systems 201. For example, the data collection device 200 may wirelessly communicate with the onboard systems 201 without (or in addition to) the connector 202 of the data collection device 200 mating with the port of the vehicle 110.

Returning to the description of the valuation system 106 shown in FIG. 1, the data collection device 200 can identify the vehicle's unique characteristics and dynamically configure itself to target available data to acquire from the vehicle 110 based on that vehicle's unique identifying information (e.g., the VIN or other identifying information). For example, the data collection device 200 can acquire the identifying information from one or more of the onboard systems 201 of the vehicle 110, using operator input to the data collection device 200, or the like. Using this identifying information, the data collection device 200 can access an internal and/or external computer memory 114 to determine what data is available from the onboard systems 201. The computer memory 114 can represent an internal solid state or static computer memory, a removable computer memory, a remotely located server, or the like. Different vehicles 110 having different onboard systems 201 may have different types and/or sets of data. The data collection device 200 can refer to the computer memory 114 to determine what data is available for the data collection device 200 to acquire.

The information that is targeted and acquired by the data collection device 200 can be referred to as vehicle dynamic payload data. Examples of this data include information on whether one or more onboard systems 201 are functioning as expected, systems have been installed or removed from the vehicle, whether the maintenance of the vehicle 110 has been kept up to date (e.g., the date of the last oil change, the number of activated warnings to the owner of the vehicle 110 such as “check engine” lights that have not been addressed or corrected), the current state of the onboard systems 201 (e.g., whether one or more lamps are working or not, the current state of charge and/or amp-hours of a battery, etc.), and the like. With respect to the data indicating what systems have been installed or removed, some owners of vehicles may add equipment, onboard systems, or the like, after purchasing the vehicles. Other owners may remove equipment while some vehicles may have equipment missing (e.g., due to part shortages, such as semiconductor chip or processors being in short supply). The dynamic payload data can identify what onboard systems are present, which onboard systems are missing, which onboard systems are not functioning, etc. Basing the valuations of the vehicles can provide a valuation that is specific to each vehicle, instead of a valuation that assumes the vehicle has all parts and equipment listed as included in the vehicle when the vehicle was originally sold or manufactured.

The dynamic payload data may include information that may not be readily discernible or discoverable by a person inspecting the vehicle 110. For example, the dynamic payload data may include information that can represent latent, as opposed to patent, defects and common issues derived from cohort analysis. This payload data that is extracted by the data collection device 200 can then be sent from the data collection device 200 to an analysis controller 101. The analysis controller 101 can represent an off-module, big data computing engine that receives the data through either a wireless and/or physically connected transfer medium (e.g., one or more wires or cables) between the data collection device 200 and the analysis controller 101. This analysis controller 101 also can be referred to as an analysis computing environment or a computing engine. The analysis controller 101 can include hardware circuitry that includes and/or is connected with one or more processors that perform the operations described herein in connection with the analysis controller 101. The analysis controller 101 may be remotely located from the vehicle 110 and/or data collection device 200. For example, the data obtained from the onboard systems 201 can be communicated from the data collection device 200 to the analysis controller 101 via one or more computer networks 101116, such as at least part of the Internet, one or more local area networks, or the like. Optionally, one or more of the onboard systems 201 can send some or all of the data to the analysis controller 101 via the network(s) 116 without the data being sent first to the data collection device 200 and then to the analysis controller 101. For example, the vehicle 110 may include wireless communication circuitry, such as cellular communication circuitry, which allows the vehicle 110 or the onboard systems 201 to communicate with the analysis controller 101 without the data collection device 200. Optionally, the data acquired by the data collection device 200 can be communicated to another device, such as a computing device 120 of a person (e.g., a mobile phone, tablet computer, smart watch, laptop computer, desktop computer, or the like).

The analysis controller 101 receives the module payload (e.g., the data obtained from the onboard systems 201 via the data collection device 200). The analysis controller 101 can perform various processing operations on all or some of this data, such as storing the data and/or processed data in the computer memory 114 or another computer memory 122. The processing operations can include normalizing values of the data, extracting pertinent data points from the data for both VIN-specific valuations and longitudinal cohort analysis valuations of like year, make, model (e.g., YMM), engine, and trim level, etc. Each of these data points (e.g., discrete items of data or datum) in the analysis controller 101 can then be mapped or matched to multiple valuation weight modelers by either table lookups or algorithmic calculations based on transactable data by the analysis controller 101. The valuation weight modelers may include mathematical models that receive values related to a vehicle 110 as inputs, and are used (e.g., by the analysis controller 101) to calculate one or more valuations for the vehicle. These inputs are described herein and can include (by way of just a few examples) sales transactions of other similar vehicles (e.g., the same or similar YMM), locations of where sales of the similar vehicles occurred), defects or components needing repair in the vehicle 110, and the like. The results from this mapping or matching to the valuation weight modelers are again mapped to multiple valuation use cases depending on how each use case weighs the status of the vehicle 110. The valuation use cases may include examples of what other, similar vehicles 110 have sold for in the same or similar area (e.g., within a threshold distance of the vehicle 110 for which the valuation is being calculated, with the threshold distance being customizable by a user). Furthermore, any historical module payloads valuation weights for that unique VIN may be included in that VIN's longitudinal retrospective analysis valuations (e.g., a historical pedigree data set 608). The historical module payloads valuation weights may include mathematical values used as weights in the valuation weight modelers. For example, these weights may be coefficient values that are multiplied by sales prices of other similar vehicles and may be obtained from a longitudinal cohort analysis of the other sales.

The analysis controller 101 optionally can receive data indicative of a physical description or state of the vehicle 110, such as physical anomalies that deviate from normal vehicle status. This data can be measured or witnessed (e.g., by a user of the data collection device 200) and/or by physical condition capture tools 701 (e.g., cameras, input devices such as keyboards or microphones, LiDAR system, sonar systems, temperature sensors, pressure sensors, etc.). This physical condition or state data can be referred to as physical payload data and can be input into the data collection device 200 (and then sent to the analysis controller 101) and/or input into the analysis controller 101 through human visual detection, image capture, scan/point cloud capture, and image post-processing methods. In contrast to the dynamic payload data which can represent latent defects of the vehicle 110, the physical payload data can represent patent defects of the vehicle 110 (e.g., defects that are not hidden or concealed from view), such as broken or chipped windows, tears in seats, dents in the body of the vehicle 110, wear and tear, etc.

This physical payload data, once brought into the analysis controller 101, can be stored, normalized, and/or analyzed to extract the pertinent data points for both VIN-specific vehicle valuations and longitudinal cohort analysis valuations of similar YMM, engine, trim level, and the like. Each physical anomaly may be mapped to multiple valuation weight modelers by the analysis controller 101 using table lookups, algorithmic calculations, or the like. For example, the analysis controller 101 can compare many vehicles 110 having the same or similar YMM, engine, trim level, etc., and the valuations of those vehicles 110 (whether obtained from the analysis controller 101 and/or sales of the other vehicles 110) to calculate a valuation of the vehicle 110 being examined. Different values of the data obtained from the vehicles 110 may be weighted in the calculation of the valuation of one of the vehicles 110. These weights can be modified based on user input, based on local demand (or lack thereof) for a particular vehicle 110, based on currently needed repairs, based on forecasted needs for repairs in the future, etc. As one example, a first vehicle 110 having a YMM, engine, and trim level that is in a location with increased market demand, that has few or no needed repairs, and a forecasted need for a future repair may have the valuation weighed to increase the valuation relative to a nearly identical second vehicle 110 that is in another location with reduced market demand, that has more needed repairs, and/or that has an increased forecasted need for future repairs.

The analysis controller 101 can combine the weighted valuations for the unique VIN with respect to the various marketplaces or use cases with real-time and historical market/use case valuation data and standardized methods to calculate a vehicle valuation. For example, the analysis controller 101 can compare the dynamic payload data of a first vehicle 110 (which can represent latent defects or issues of the vehicle 110) with the dynamic payload data of other vehicles 110 having a similar or identical YMM, engine, trim level, etc. to determine a dynamic payload valuation of the first vehicle 110 (also referred to as a vehicle dynamic payload weighted valuation). The analysis controller 101 can compare the physical payload data of a first vehicle 110 (which can represent patent defects or issues of the vehicle 110) with the physical payload data of other vehicles 110 having a similar or identical YMM, engine, trim level, etc. to determine a physical payload valuation of the first vehicle 110 (also referred to as a physical payload weighted valuations). These valuations (e.g., the valuation based on the comparison of dynamic payload data and the valuation based on the comparison of physical payload data) can be combined (e.g., averaged) by the analysis controller 101 to calculate a valuation or combined valuation of the first vehicle 110.

This combined vehicle valuation may then be used as a baseline valuation to which the vehicle dynamic payload weighted valuation and the physical payload weighted valuation are used to establish a statistically valid valuation for that specific VIN which is targeted to a use case. A use case can be the situation in which the seller, buyer, or other party is looking to acquire or dispose of the vehicle 110, such as by selling the vehicle 110 to a customer from a retail dealer, trading the vehicle 110 for another vehicle 110, selling or buying the vehicle 110 at an auction, floor planning the vehicle 110, underwriting a warranty on the vehicle 110, etc. The summation of the payloads' weighted valuations targeted to various use cases is shown in Table 3: Collateralized Value of Asset. Each use case shown in the table highlights the difference in the weighted valuations for that use case. This extends to any use cases that requires a scientifically developed VIN-specific valuation such as residual insurance values, reconditioning valuations, repair valuations, and off-lease residual valuations. Reconditioning valuations may be valuations of vehicles after the vehicles are prepared for sale (e.g., which may include body work, paint work, mechanical repairs, and the like). For example, the combined valuation of the same vehicle 110 may significantly vary based on whether the vehicle 110 is being traded, sold, or bought at an auction, purchased using financing or a loan, or purchased or sold from a retail lot.

TABLE 3
Collateralized Value of Asset

| Vehicle | | | | |
|---|---|---|---|---|
| Valuation | Trade | Auction | Loan | Retail |
| Vehicle Exhibit “D” | $11,200 | $12,129 | $10,175 | $13,400 |

### Source: Galves Market Data

Furthermore, the analysis controller 101 can store and analyze the longitudinal cohort analysis of the weighted valuations with respect to the YMM, powertrain, trim level, and the like, and the standard measures are derived through non-parametric analysis. Unlike parametric analysis which assumes a pre-determined normalized distribution of the data, the analysis controller 101 can use a non-parametric statistical approach where the data itself establishes the distribution without using a pre-determined norm. The richer the data set becomes (e.g., which may occur with increasing amounts of data collected from increasing numbers of vehicles 110), the better the distribution is determined. This can be especially true in the vehicle evaluations as the vast, dynamic nature of vehicle conditions makes a parametric analysis inaccurate as such an analysis relates to valuation due to the valuation parameters always changing and new parameters being added. The non-parametric analysis of the longitudinal cohort data provides predictive analytics for maintenance, safety, part failure, and emissions compliance information. The longitudinal cohort analysis data is used during the valuation of a specific VIN and is also used as a general use case valuation weight for an entire fleet based on YMM, powertrain, trim level, or the like. Furthermore, the discovery of issues that require repair and/or replacement parts on the vehicle can aid in determining trends for parts store stocking, repair shop training, and extended warranty coverage.

The VIN-specific valuation, which is accurately and scientifically developed, can be the standard measuring system for a variety of valuation use cases. Whether these valuations are used for consumer protection during the trade-in process, lease return, loan process, or purchase process, the valuations are a guaranteed constant for each use case and can be collateralized/insured for that valuation at the time of the transaction.

The valuation system 100 optionally can include and/or communicate with a disposition system 120. The disposition system 120 is schematically illustrated in FIG. 1 but can represent one or more systems or assemblies that can receive output from the analysis controller 101 to implement one or more responsive actions. As one example, the disposition system 120 can represent one or more robots or robotic systems that can disassemble and/or assemble parts of the vehicle 110 responsive to a signal being sent from the analysis controller 101 to the disposition system 120. The analysis controller 101 can calculate valuations of the vehicle 110 that reveal that repairing one or more parts of the vehicle 110 will increase the valuation of the vehicle 110. The analysis controller 101 can send a control signal that directs the disposition system 120 to automatically take apart and/or replace the parts needing repair of the vehicle 110 to increase the valuation of the vehicle 110. The analysis controller 101 optionally can send a signal to the disposition system 120 that directs the disposition system 120 to take the vehicle 110 apart for selling individual parts of the vehicle 110, as described herein.

As another example, the disposition system 120 can represent one or more trucks or other vehicles that can carry, tow, or push the vehicle 110 that has been evaluated by the analysis controller 101 responsive to a signal being sent from the analysis controller 101 to the disposition system 120. The analysis controller 101 can calculate valuations of the vehicle 110 that result or are connected with a sale, purchase, or other disposition of the vehicle 110. Responsive to receiving a confirmation (e.g., from a user or other device) that the vehicle 110 has been disposed, the analysis controller 101 can communicate a control signal to the disposition system 120 to direct or control the disposition system 120 to tow, carry, or push the vehicle 110 to another location (e.g., the location of the buyer). With respect to self-driving vehicles, this control signal can cause the disposition system 120 to automatically self-drive the vehicle 110 to the other location.

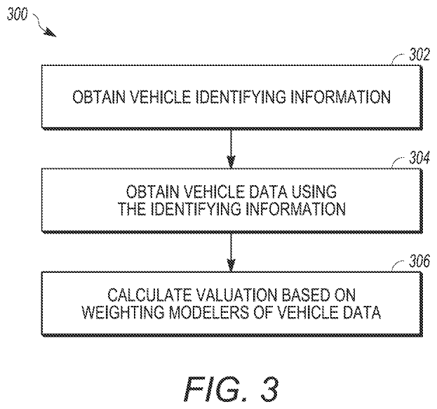

FIG. 3 illustrates a flowchart of one example of a method 300 for valuating an asset. The method 300 can represent at least some of the operations performed by the valuation system 106 in calculating a valuation for the vehicle 110 according to one embodiment. At 302, identifying information of the vehicle 110 is obtained. For example, a unique VIN number representing a specific vehicle 110 is obtained from user input or the data collection device 200. At 304, the identifying information is used (e.g., by the data collection device 200) to obtain both physical payload data and vehicle dynamic payload data from the onboard systems 201. At 306, the physical payload data and the vehicle dynamic payload data are used to produce data that pertains to the transactional value of the vehicle 110 (e.g., using the analysis controller 101). A weighted valuation can be derived by the analysis controller 101 using this data that is fed into weighted valuation modelers to determine a VIN-specific valuation for the use case of the vehicle 110.

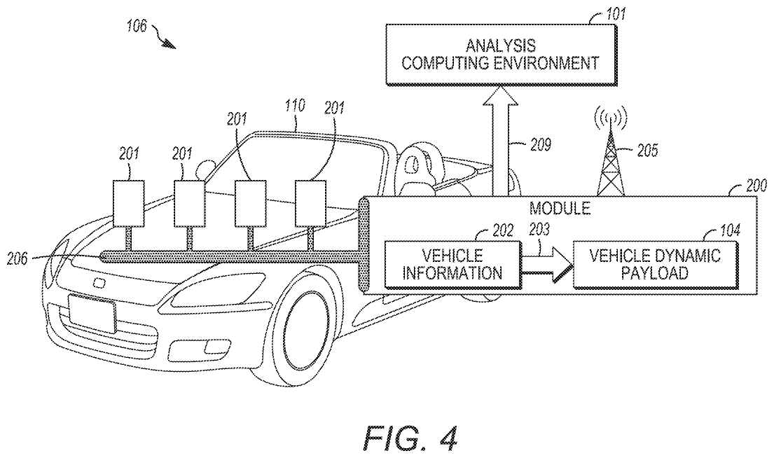

FIG. 4 illustrates another example of the valuation system 106 described herein. The onboard systems 201 shown in FIG. 1 can be represented by multiple controllers or computers connected through a communication network backbone 206 of the vehicle 110. The backbone 206 can represent one or more conductive pathways, such as wires, cables, buses, or the like. Optionally, the backbone 206 can additionally or alternatively represent one or more wireless communication pathways or channels. The backbone 206 can be accessed through the data collection device 200 (labeled as “Module” in FIG. 4) or other telematics hardware that is temporarily or permanently connected to the communication network backbone 206. Vehicle information 203 can be decoded by the data collection device 200 from raw vehicle data into actionable vehicle dynamic payload data 104. This payload data may be transferred to the analysis controller 101 (labeled “Analysis Computing Environment” in FIG. 4) by either a direct physical connection 209 (e.g., cables, wires, buses, etc.) from the data collection device 200 and/or a wireless connection 205 from the data collection device 200. The analysis controller 101 may be located in proximity to the vehicle 110 (e.g., within a threshold distance, such as within ten meters, within one hundred meters, etc.) or located remotely from the vehicle 110 (e.g., more than the threshold distance or more than one kilometer).

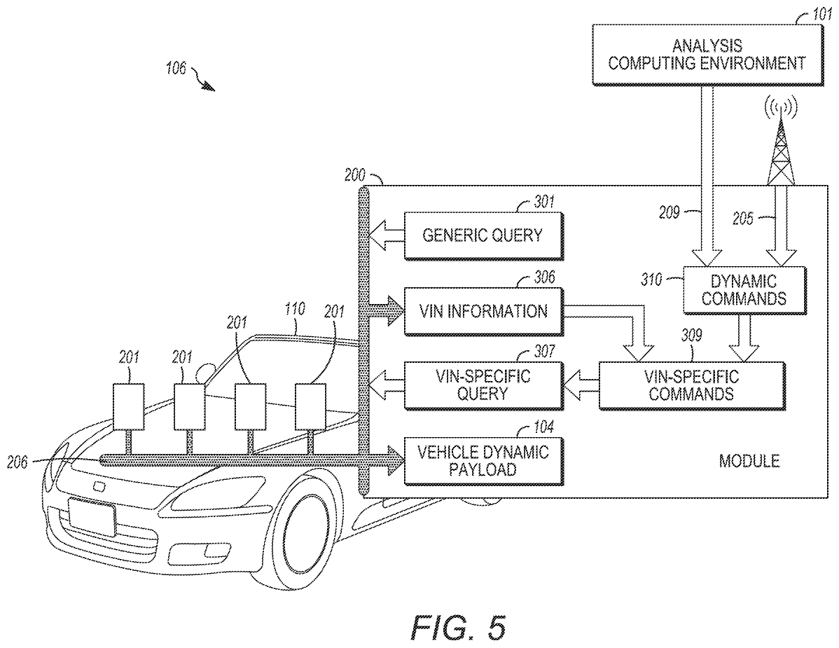

FIG. 5 illustrates another diagram of the valuation system 106 extracting pertinent vehicle identification, status, and diagnostics according to one example. The data collection device 200 can be connected to the vehicle's internal controllers/computers 201 through the vehicle's communications network backbone 206. A generic query command 301 can be sent from the data collection device 200 (labeled “Module” in FIG. 5) to the vehicle's controllers/computers 201 to extract identifying information 306 (e.g., the VIN of the vehicle 110) from the vehicle controllers/computers 301 for identifying the specific vehicle 110. The VIN number can be decoded from the identifying information 306 by the data collection device 200, and the exact vehicle YMM and equipment information can be identified based on the VIN number. For example, this information may be stored in the memory 114 and/or 122 (shown in FIG. 1). Using the exact vehicle identification, VIN-specific commands 309 can then be developed by the data collection device 200 into a VIN-specific query 307 which is sent to the appropriate controller/computers 201 of the vehicle 110. The vehicle's requested controller/computers 201 can return targeted data which is decoded by the data collection device 200 and built into the vehicle dynamic payload data 104. A dynamic commands database 310 can be stored in the memory 114 and may be consulted or referenced when the data collection device 200 builds the VIN-specific commands 309. The database 310 can be kept up to date through either over-the-air updates 205 or direct module wired connection updates 209 as dictated by the analysis controller 101. This can help ensure that the data collection device 200 can adapt to new use case required data.

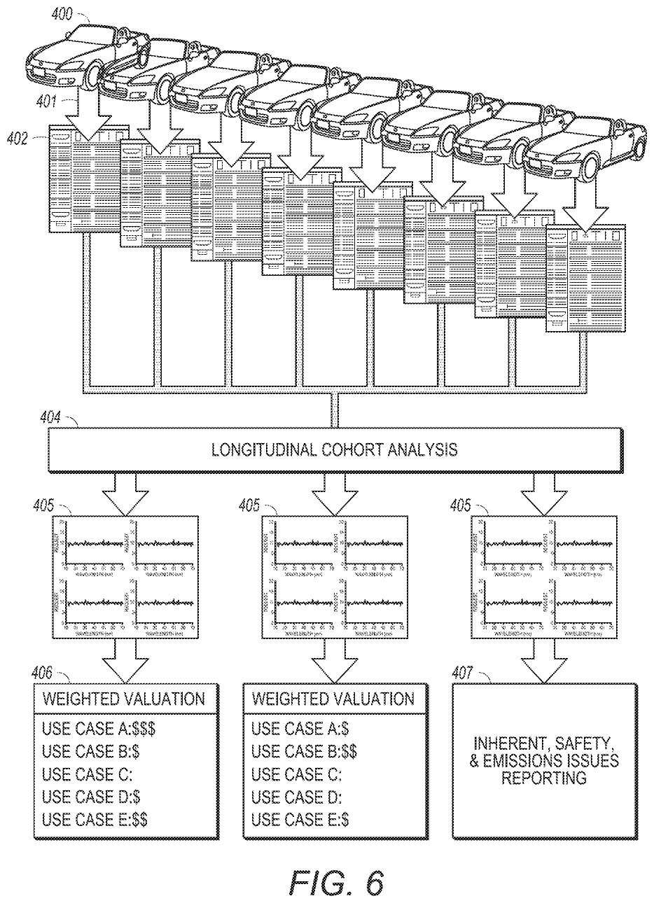

FIG. 6 illustrates a diagram of operation of the valuation system 106 in performing a longitudinal cohort analysis. The VIN-specific weighted vehicle payload data 401 can be extracted from several vehicles 400 (each of which can represent one of the vehicles 110) using the data collection device(s) 200 and/or other telematic devices. This vehicle payload data may be analyzed by the analysis controller 101, which produces a normalized, decoded, and calculated VIN-specific data object 402 for that vehicle 110, 400. YMM, powertrain, standard/optional equipment, and trim level data can be clustered together and fed into a longitudinal cohort analysis modeler 404 where information, statuses, and diagnostics of the vehicle 110, 400 are analyzed for trends and statistical probabilities and anomalies by the analysis controller 101. The longitudinal cohort analysis modeler 404 may represent one or more software applications that operate on and/or direct operations of the analysis controller 101 to perform calculations such as a longitudinal cohort analysis.

For example, the longitudinal cohort analysis modeler 404 can examine information including the location of the vehicle 110, 400 and vehicle mileage 603 when the data 401 was collected, and develop a statistical probability when problems occur based on similarly equipped vehicles in the YMM, powertrain, standard/optional equipment, and trim level fleet. For example, the longitudinal cohort analysis modeler 404 can direct the analysis controller 101 to examine data obtained from other vehicles 110, 400 having the same or similar (e.g., within a threshold) YMM, powertrain, equipment, and/or trim level to determine when failures or other issues with one or more onboard systems is more likely to occur for the vehicle 110, 400 being examined.

When issues are indicated at certain thresholds that no longer follow a bell curve statistical result 405, the longitudinal cohort analysis modeler 404 develops or updates weighted valuation maps 406 for the marketplaces that would be affected by the issue. These maps 406 can represent lists, tables, or maps that identify locations of the vehicles 110, 400 that are more likely to have the failures or issues (relative to other areas where the vehicles 110, 400 are less likely to have the failures or issues). In the event that the issue would be of interest to governing agencies such as NHTSA, EPA, National Auto Auction Association, Insurance Companies, or Original Equipment Manufacturers (OEM), the inherent problem, safety, or emissions statistics could be shared as it applies to the entire fleet of vehicles 110, 400 and may not be just VIN-specific. In doing so, this analysis can identify potential upcoming failures across a wide range of the vehicles 110, 400 before the failures occur, which can assist the agencies or companies in issuing recall notifications before serious accidents occur. In one example, the analysis controller 101 can issue a report 407 that is sent to agencies, companies, OEM, vehicle owners, etc., warning of the likely upcoming failures of one or more onboard systems 201 of the vehicles 110, 400.

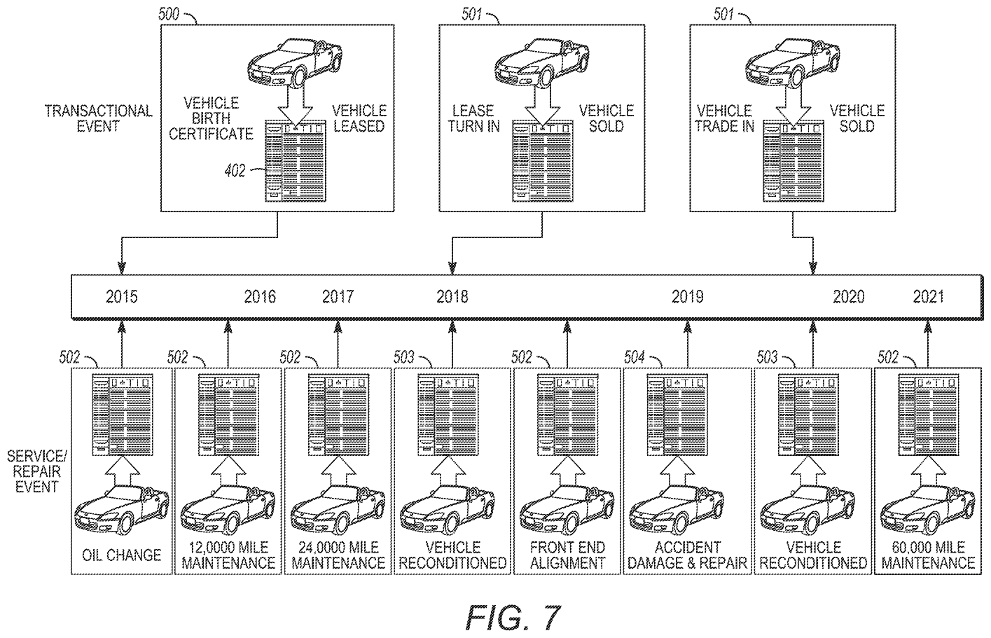

FIG. 7 illustrates a diagram of operation of the valuation system 106 performing longitudinal retrospective analysis and effects of VIN-specific valuations. The valuation system 106 can be used to gather condition information 500 for a vehicle 110, which may include the vehicle dynamic payload data and physical payload data for the vehicle 110. The analysis controller 101 can divide different portions of this information that relate to the physical care and custody or ownership of the vehicle into different categories. For example, the analysis controller 101 can associate at least some of this information with one or more transactional events that involve ownership of the vehicle 110 changing. As another example, the analysis controller 101 can associate at least some of this same or different information with one or more service and/or repair events where the vehicle 110 is brought in for service. As another example, the analysis controller 101 can associate this same or different information with one or more crash events and the subsequent proper documented repairing of the vehicle 110. These events (to which the data from the vehicle 110 can be associated) may include normal (e.g., regularly scheduled or due on a mileage basis) maintenance 502, equipment failure repair, inspections, and accident repair 504. Transactional events also may involve condition analysis and (if required) a reconditioning event 503 of the vehicle 110 to prepare the vehicle 110 for its owner or next owner of the vehicle 110. Each data set collection from either a transactional or service/repair event may add to the pedigree data set 608 of the vehicle 110. This allows the weighted valuation of the condition of the vehicle 110 to no longer be subjective as there is now hard (e.g., objective) data showing how the vehicle 110 was serviced throughout the lifecycle of the vehicle 110, further driving to the scientifically developed valuation of the vehicle 110 for various use cases.

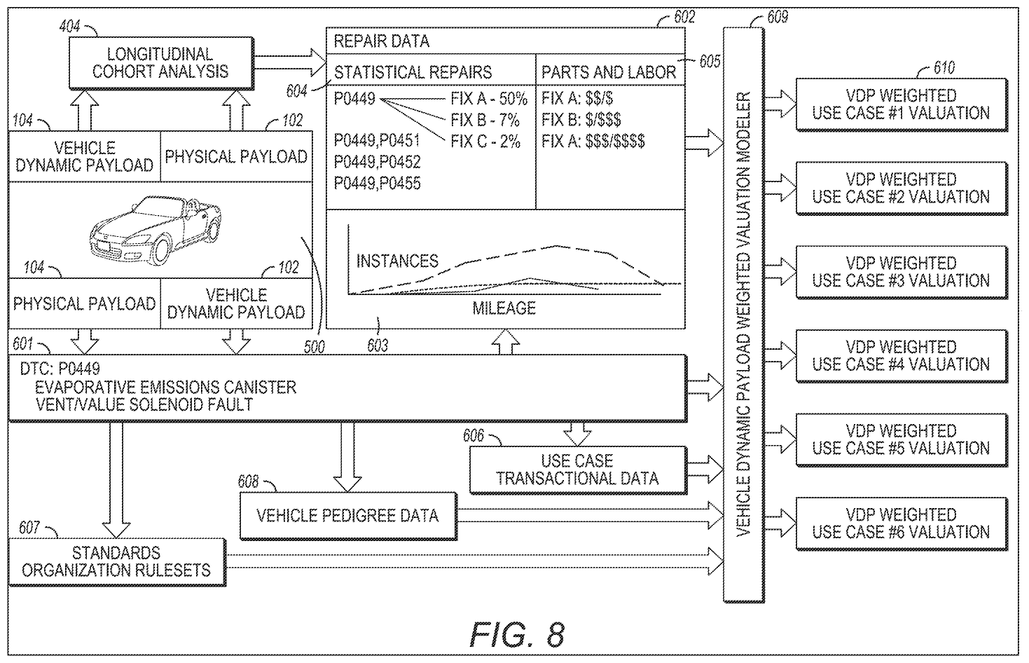

FIG. 8 illustrates operation of the valuation system 106 with respect to the weighting valuation modeler for VIN-specific valuations (e.g., valuations that are specific to individual vehicles). The data collection device 200 of the valuation system 106 can be used to gather condition information 500 of the vehicle 110. This condition information 500 can the vehicle dynamic payload data 102 and the physical payload data 104 described above. The analysis controller 101 can extract vehicle diagnostic and status markers 601 from the vehicle dynamic payload data 102. These markers 601 can be diagnostic status codes associated with different states or conditions of the onboard systems 201 of the vehicle 110. For example, a marker 601 can indicate that a sensor in a vehicle seat that is used to detect the weight of a passenger (and then activate or ensure that airbags are activated) is not functional, another marker 601 can indicate whether a fuse has blown, another marker 601 can indicate that a check engine light has been active in the vehicle 110 for an indicated period of time, etc. Different makes and/or models of the vehicles 110 may use different markers 601 and may use different markers 601 to indicate the same state or condition of the same onboard system 201 in different vehicles 110.

The analysis controller 101 can access a table, list, or other memory structure that associates different markers 601 of different makes and/or models of vehicles 110 with different identifiers. The identifiers can be plain-English explanations of the issues represented by the markers 601. For example, most markers 601 may be unintelligible to owners of vehicles 110, but the identifiers can include more information that can be understood by owners of vehicles 110. The analysis controller 101 can provide the identifiers in a report or other output (e.g., that is presented on an output device, such as a display device, or printed on a hard copy of a report) to assist persons reading the report or other output in better understanding issues with a vehicle 110.

The analysis controller 101 can extract, decode, and map the markers 601 into several valuation driven algorithms. These algorithms can map a weighted VIN-specific valuation against the longitudinal cohort analysis modeler 404 output with vehicles 110 that exhibit the same markers and use case transactional results 606. The use case transactional results 606 can include the values or prices at which other similar vehicles 110 were sold or disposed (e.g., through recycling, retail sales, wholesales, auction sales, etc.). The markers 601 also can be mapped (e.g., matched) to rulesets 607 from standards organizations such as NHTSA, NAAA, and the EPA to algorithmically determine a weighted valuation applicable to the specific issues addressed by these standards organizations. For example, different issues with or states of a vehicle 110 can be represented by various markers 601, which are matched up with rulesets 607 that associate costs to repair or correct the issues or states. These costs can be used to calculate the value of the vehicle 110.

Furthermore, individual markers 601 can be analyzed by the analysis controller 101 for any similar marker clusters that were extracted from the dataset output from the longitudinal cohort analysis modeler 404 of comparable YMM, engine, and/or trim levels. A cluster of markers 601 can represent a group of different markers 601 that appear together more often in the data obtained from the vehicles 110 than other markers 601 or groups of markers 601. These clusters of markers 601 or individual markers 601 can be mapped by the analysis controller 101 to a cumulative weighted repair valuation 602. This repair valuation 602 can represent the value of the vehicle 110 if all issues or repairs identified by the markers 601 are completed. Alternatively, the repair valuation 602 can represent the value of the vehicle 110 if the issues or repairs identified by the markers 601 are not completed.

The markers 601 may be broken down (e.g., separated out) to map or match the markers 601 to statistical probabilities of the marker 601 to non-parametrically driven repair information 604, which is then mapped to parts and labor cost requirements to accurately identify the effect on the valuation. For example, the markers 601 are extracted, the issues or problems with a vehicle 110 that are associated with or that may have given rise to the markers 601 are identified, and the costs of correcting or fixing these issues or faults are identified. All of these mapped and calculated data points may be input into the weighted valuation modeler 609 and the analysis controller 101 can algorithmically determine or calculate a vehicle dynamic payload weighted valuation 610 using the data points and the modeler 609 for the targeted use case (e.g., the manner in which the vehicle 110 for which a valuation is being calculated is to be acquired or disposed).

The analysis controller 101 may use the collected condition information 500 including the vehicle dynamic payload data and the physical payload data 102 for the vehicle 110 for the specific VIN to develop the historical pedigree data set 608 of the vehicle 110. The historical pedigree data set 608 can include some or all of the information relating to prior completed repairs of the vehicle 110, as may be witnessed or identified by the analysis controller 101 via changes in the vehicle dynamic payload data. The collected condition information 500 (including the vehicle dynamic payload data and the physical payload data for the vehicle 110) may be used by the analysis controller 101 to evaluate the condition of the VIN-specific data set based on vehicle mileage 603 at the time of data collection.

For example, the same vehicle dynamic payload data and/or the same physical payload data for vehicles having different mileage may be evaluated differently by the analysis controller 101 due to the different mileage. The analysis controller 101 can map the impact of the milage on the condition of the vehicle 110 to the use-based valuation (e.g., different values may be calculated based on whether the vehicle is to be sold at a retail location, sold at an auction, or recycled). Furthermore, through non-parametric statistical modeling, the analysis controller 101 can weigh causality mapping between a cause of an identified issue 601 of the vehicle 110 and repair description 602 of the issue based on the mileage 603, and also can weigh predicted failures and proactive maintenance 605 for use case valuation. This can be used by the analysis controller 110 to build or form a weighted valuation 610 of the vehicle 110 as it relates to the lifecycle of the vehicle 110.

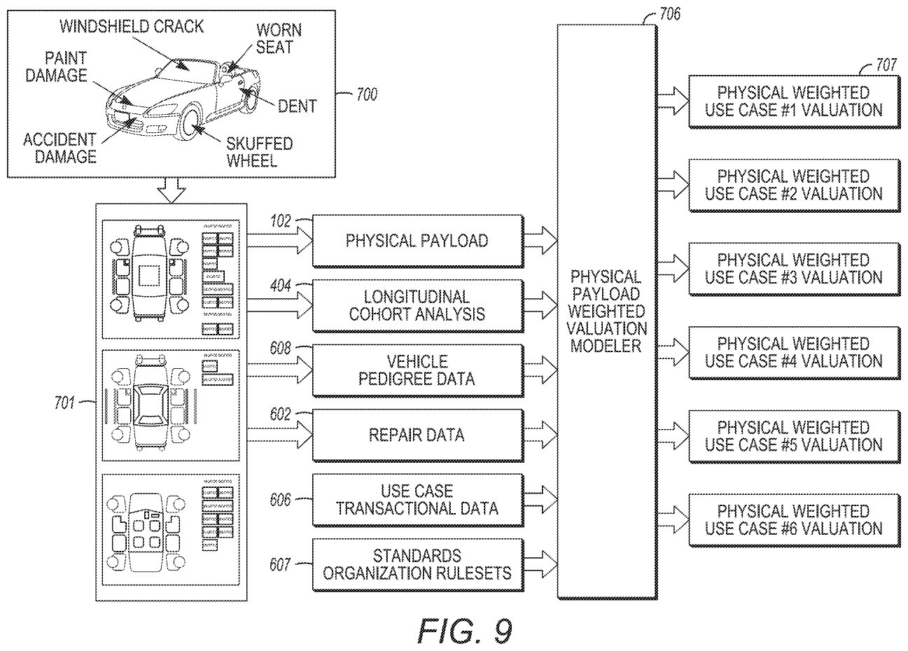

FIG. 9 illustrates operation of the valuation system 106 with respect to with respect to the weighting valuation modeler for VIN-specific valuations. The data acquisition device of the system can be used to gather physical vehicle conditions 700 using output 701 from the physical condition capture tools 701 described above. This output may include vehicle images, anomalies, derived condition markers, and the like, at least some of which may be extracted from the physical payload data. These markers can then be decoded and mapped to several valuation driven algorithms that map a weighted VIN-specific valuation against vehicles 110 from the longitudinal cohort analysis dataset 404 that exhibit these same or similar markers and the use case transactional results 606. For example, the analysis controller 110 can evaluate what other vehicles 110 having the same or similar YMM, powertrain, standard/optional equipment, and/or trim level and some or all of the same markers sold for during various dispositions of the vehicles 110. The markers also may be mapped to the rulesets 607 from standards organizations such as NHTSA and the NAAA to algorithmically determine a weighted valuation applicable to the specific issues addressed by these standards organizations. For example, the issues identified by the markers can be associated with different costs to fix or replace parts to fix the issues. These costs of parts and/or labor can be factored into the valuation.

Individual markers may be analyzed by the analysis controller 110 for any similar marker clusters or groups that were extracted from the longitudinal cohort analysis dataset 404 of comparable YMM, powertrain, standard/optional equipment, and/or trim levels. These clusters of markers or individual markers can be mapped to a cumulative repair (also known as recondition) valuation 602, similar to as described above. For example, individual markers can be associated (e.g., in one or more of the memories) with various costs and/or values. The repair data (e.g., to fix the issues identified by the markers) can be broken down to map to statistical probabilities of the marker to non-parametrically driven repair information, which is then mapped to parts and labor cost requirements to accurately identify the effect on the valuation of vehicle 110. For example, prior valuations, sale prices, auction prices, recycled values, etc., of other vehicles 110 having more of the same markers 601 or groups of the markers 601 as the vehicle 110 being evaluated may be more indicative of the value of the vehicle 110 being evaluated than other vehicles 110 having fewer markers 601 in common with the vehicle 110 being evaluated. All of these mapped and calculated data points (102, 404, 608, 602, 606, 607) can then be fed into the physical payload weighted valuation modeler 706 to algorithmically determine a physical payload weighted valuation 707 for the targeted use case of the vehicle 110 (e.g., the manner in which this vehicle 110 will be or is likely to be disposed or acquired).

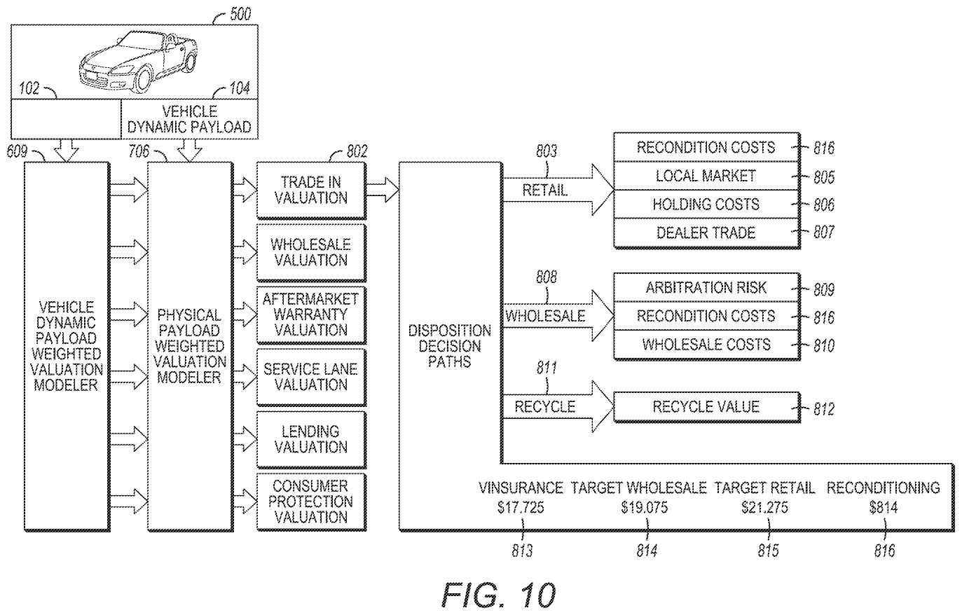

FIG. 10 illustrates a diagram of operation of the valuation system 106 to determine an aftermarket warranty valuation 1000 of a vehicle 110. This valuation may represent the value of the vehicle 110 for an aftermarket equipment warranty. The data collection device of the valuation system 106 may be used to gather condition information 500 of the vehicle 110, such as the vehicle dynamic payload data 104 and the physical payload data 102. The markers 601 can be extracted from the vehicle dynamic payload data 104 and/or the physical payload data 102, decoded (e.g., to determine what issues are associated with or give rise to the markers 601), mapped onto several valuation driven algorithms, and fed into the vehicle dynamic payload weighted valuation modeler 609 and the physical payload weighted valuation modeler 706. From these modelers, the analysis controller 101 can calculate or obtain a VIN-specific valuation 813 (e.g., a valuation specific to the vehicle 110 being evaluated) for the use case (e.g., selling wholesale 814, selling at retail 815, the value of the vehicle as reconditioned 816, etc.) which may be used as guidance to various disposition decision paths (e.g., selling the vehicle 110 at wholesale, selling the vehicle 110 at a retail location, fixing the vehicle 110, recycling the vehicle 110, etc.). The disposition decision paths in the illustrated example include a retail sale where the vehicle 110 is acquired and listed for sale on a dealer lot or online, a wholesale sale where the vehicle 110 is acquired and sent to either a physical or online wholesale auction marketplace, or recycle where the vehicle 110 is acquired and then sold to a recycling center for disassembly and the parts from the vehicle 110 are sold individually.

The analysis controller 101 can consider or receive one or more cost factors for retail vehicle decisions. These factors may include reconditioning costs 816 or the cost to repair and prepare the vehicle 110 for sale (which can be based on the errors, failures, or the like, indicated by the markers 701), local market demand 805 (which can indicate the local market vehicle interest level in acquiring the vehicle 110 and may be determined by the analysis controller 101 through non-parametric analysis to produce a weighted value), holding costs 806 which illustrate the calculated depreciation of the vehicle 110 using time against the valuation modelers 609, 706 to algorithmically determine an asset valuation melt rate (or a depreciation rate), a dealer trade value 807 (e.g., the statistical analysis of vehicle dealers in a defined or designated radius who have sold vehicles with similar YMM, powertrain, standard/optional equipment, and/or trim levels, and/or other cost factors. The combination of these factors can be balanced by the analysis controller 101 against the VIN-specific valuation 813, 814, 815, 816 to remove subjective evaluations of a trade in and replace with scientifically derived or objective values and decision advice for vehicle 110.

In the event that the retail disposition decision path 803 was not viable or not selected by the owner or purchaser of the vehicle 110, the next disposition step may be to compare the VIN-specific trade-in value of the vehicle 110 with respect to the wholesale market value. The wholesale market value can be the target price for a wholesale vehicle marketplace (e.g., a wholesale auction for dealership-to-dealership transactions). The analysis controller 101 can calculate the wholesale market value based on one or more wholesale decision factors such as an arbitration risk or likelihood 809 that the condition of the vehicle 110 derived from the modelers 609, 706 would be subjected to arbitration as ruled by the National Auto Auction Association (NAAA), reconditioning costs 816 which consider whether repairing the vehicle 110 will add value at the wholesale market to increase profit or reduce the risk of arbitration, wholesale costs 810 which include fees associated with wholesale consignment services that can decrease the profit gained on sale of the vehicle 110, and/or other factors. The combination of these decision factors balanced by the analysis controller 101 against the VIN-specific valuation 813, 814, 815, 816 can remove or reduce the subjective evaluation of a trade-in of the vehicle 110 and replace the subjective evaluation with a scientifically derived or objective value and decision advice. In the event that the wholesale disposition decision path 808 is taken (e.g., the owner decides to sell the vehicle 110 at wholesale), the first guaranteed bid for the vehicle 110 can be set by the VIN-based valuation 813 (also referred to as VINsurance valuation, which is a valuation specific to the VIN of the vehicle and may be different for different vehicles having the identical YMM, powertrain, optional equipment, miles, etc. based on other factors described herein). The VINsurance of a vehicle 110 can be a guaranteed purchase price or other purchase price for a vehicle 110 that is developed using one or more of the methods and systems described herein. The VIN-specific valuation can be used to eliminate an “if bid” for a vehicle being sold at an auction. This type of bid may be used where the vehicle has a bid for purchasing the vehicle, but the bid may be lower than a reserve price or bid for the consigner of the vehicle. Such a bid may place possession of the vehicle (and the money used to purchase the vehicle) in an indeterminate state as the bidder may not know whether they will take possession of the vehicle for an extended period of time (e.g., up to 48 hours) to determine whether the bid will be accepted. Using the VIN-specific valuation can eliminate or reduce this delay as the valuation is objectively derived and can be trusted by the cosigner and bidder for the vehicle.

In the event that the retail disposition decision path 803 and the wholesale disposition decision path 808 were not viable or selected, the analysis controller 101 can calculate a VIN-specific trade-in value of the vehicle 110 with respect to a recycle disposition decision path 811. In the event that the condition of the vehicle 110 is such that reconditioning costs exceed the value of the vehicle 110, the profit margins are too little, the vehicle 110 is too old or cannot be fixed, or there is no interest in the vehicle 110 on the market, the recycle value for the vehicle 110 can be evaluated. Many times, the sum of the vehicle's individual parts is greater than the whole, and recycle centers (e.g., scrap yards, salvage yards, and junk yards) will purchase vehicles for the parts inventory of the centers. The recycle value of the vehicle 110 can be compared with the VIN-specific valuation 813, 814, 815, 816 by the analysis controller 101 to remove the subjective evaluation of a trade in and replace it with scientifically derived values and decision advice to provide an objective recommendation from the analysis controller 101 of whether to keep the vehicle 110 or recycle the vehicle 110.

Recycling yards or companies also may use this information to determine which parts or onboard systems of a vehicle are working, and which are not working. This can help eliminate the recycling yards or companies from removing and selling broken parts of a vehicle. This can be helpful for wrecked vehicles and high mileage vehicles. For example, if an air bag system is revealed to be faulty or non-operational based on the data obtained from the vehicle, the derived markers, and the like, then the recycling yard can quickly determine that the air bag system is non-operational and can refrain from expending time or resource to remove and try to sell the air bag system.

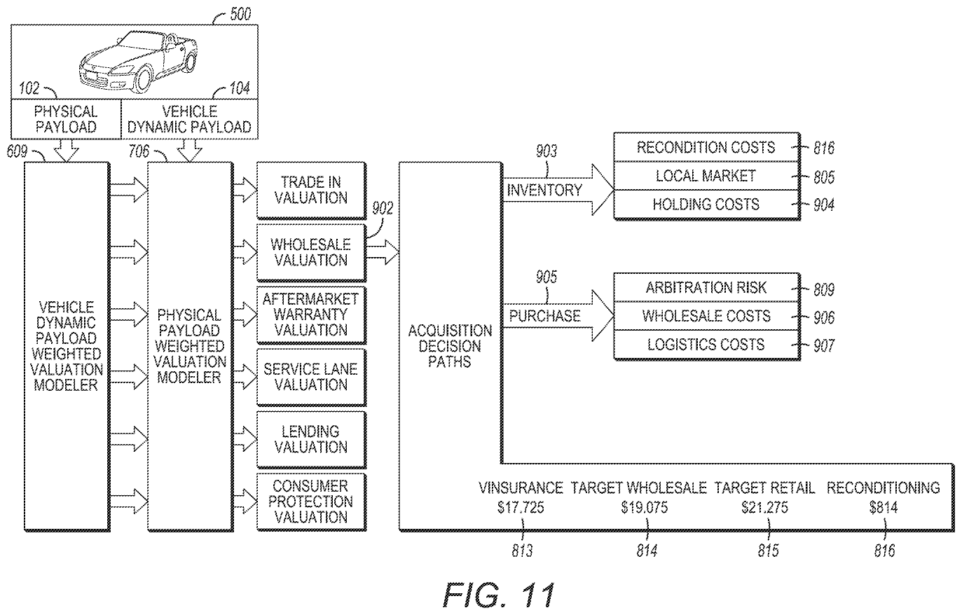

FIG. 11 illustrates operation of the valuation system 106 to gain insight during the disposition decision paths available when evaluating acquiring a vehicle 110 from the wholesale automotive environment, either in-lane (e.g., at an auction), outside the gate (e.g., acquiring the vehicle via an auction at a dealership that has not taken possession of the vehicle 110), or via an online sale to find the best end user which will bring a premium sales price for the vehicle 110. The analysis controller 101 can gather condition information 500 of the vehicle, such as the vehicle dynamic payload data 104 and physical payload data 102 of the vehicle 110. The analysis controller 101 can extract derived condition markers from the vehicle dynamic payload data 104 and/or the physical payload data 102. The analysis controller 101 can decode the markers, map the markers into several valuation driven algorithms, and feed the markers into the vehicle dynamic payload weighted valuation modeler 609 and the physical payload weighted valuation modeler 706, as described above. The result of these modelers can provide a VIN-specific valuation 902 for this use case, which can be provided to a user as guidance to various acquisition decision paths that guide the buyer to make a scientifically derived decision to purchase or not purchase the vehicle 110. For example, a disposition decision can be made by a user of the valuation system 106 based on output provided by the analysis controller 101 and/or the analysis controller 101 can provide a disposition recommendation to the user. The disposition decision or recommendation may include acquiring the vehicle 110 to keep in an inventory 903 (e.g., decision or recommendation weighs in favor of keeping the vehicle 110 within an inventory due to current inventory, customer interest, profit goals, and the like), or purchasing 905 the vehicle 110 where the condition of the vehicle 110 as driven or determined by the modelers 609, 706 balance the risks and costs against the VIN-specific valuation and decision or recommendation to keep the vehicle 110 in inventory.

The analysis controller 101 can base the decision or recommendation based on several cost or decision factors. These factors for the inventory acquisition decision path 903 may include reconditioning costs 816 which can include the cost to repair and prepare the vehicle 110 for sale. Another factor can include local market demand 805, which is the local market interest level determined through non-parametric analysis performed by the analysis controller 101 to produce a weighted value of the vehicle 110. For example, where a particular location where end user demand is higher thus commanding premium prices, the analysis controller 101 can increase the calculated valuation of the vehicle 110 by using increased weights. The analysis controller 101 can decrease the calculated valuation of the vehicle 110 by using decreased weights in areas where end user demand is lower. Another factor that the analysis controller 110 can use is holding costs 904, which represent or include calculated depreciation of the vehicle 110 using time against the valuation modelers 609, 706 to algorithmically determine an asset valuation melt rate. For example, the analysis controller 101 can calculate different forecasted values of the vehicle 110 over time to determine how holding the vehicle 110 will potentially impact future values of the vehicle 110. The combination of these decision factors balanced against the VIN-specific valuation 813, 814, 815, 816 may remove the subjective evaluation of a wholesale bid and purchase and replace it with scientifically derived values and decision advice.

In the event that the analysis controller 101 does not recommend or the user does not select the acquisition disposition decision path 803, the analysis controller 101 can calculate the trade-in value of the vehicle 110 in the wholesale market. The analysis controller 101 can evaluate several factors to determine whether to recommend the purchase disposition decision path 905 (e.g., the recommendation to purchase one vehicle 110 by trading in another vehicle 110). These factors can include the arbitration risk 809 (e.g., is the condition of the vehicle 110 derived from the modelers 609, 706 such that the vehicle 110 will be or has an increased likelihood of being subjected to arbitration as ruled by the NAAA, the reconditioning costs 816 which can indicate whether repairing the vehicle 110 will add value at the wholesale market or reduce the arbitration risk, wholesale costs 906 which are fees associated with wholesale buyer services, and logistics costs 907 which include costs associated with transporting the vehicle 110 to a resale location. The combination of these decision factors balanced against the VIN-specific valuation 813, 814, 815, 816 may remove the subjective evaluation of a wholesale purchase decision and replace it with scientifically derived values and decision advice. In the event that the acquisition decision path results in the vehicle 110 being recommended for purchase from the wholesale market, the VIN-based valuation 813 may be recalculated by the analysis controller 101 and the vehicle's valuation is now shifted back to operation of the valuation system 106 shown in FIG. 10 and the retail disposition decision path 803 for sale price guidance.

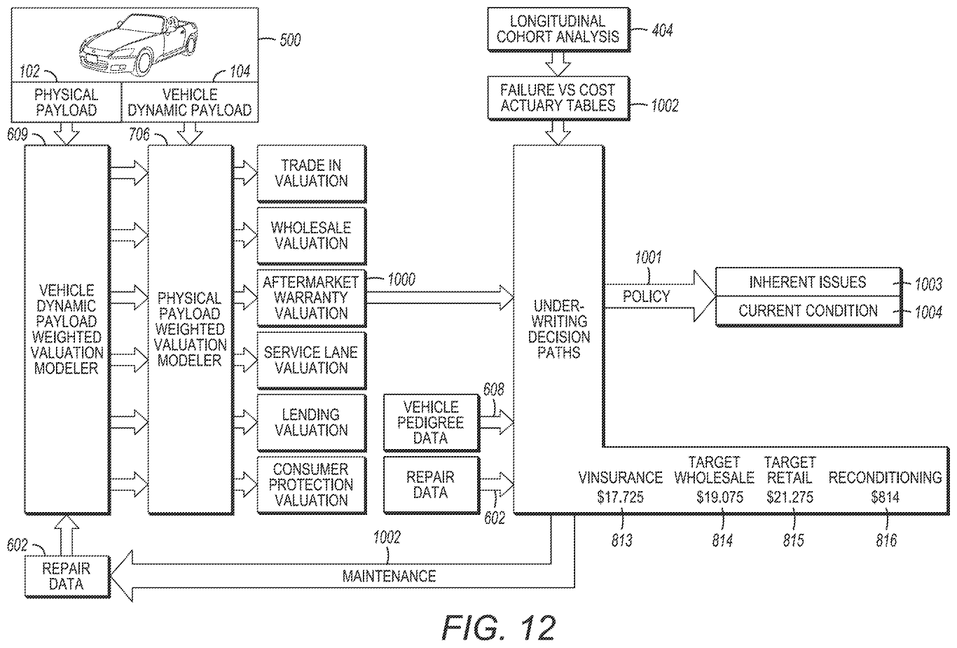

FIG. 12 illustrates operation of the valuation system 106 to gain insight during the disposition decision paths available when underwriting a warranty policy 1001 for a vehicle 110 in a retail automotive environment. The valuation system 106 may be used to gather condition information 500 of the vehicle 110 including the vehicle dynamic payload data and the physical payload data for the vehicle 110 (e.g., using the data collection device and/or user input). The analysis controller 101 can examine this data and derive or extract condition markers from the data. The markers can be decoded and mapped to several valuation driven algorithms and fed into the vehicle dynamic payload weighted valuation modeler 609 and the physical payload weighted valuation modeler 706 to calculate a value of the vehicle 110 (such as an aftermarket warranty valuation 1000), as described herein. The result of these modelers to provide the VIN-specific aftermarket warranty valuation 1000 for this use case, which can be used as guidance or as a recommendation from the analysis controller 101 to an underwriting decision path that guides or recommends the underwriter to make a scientifically derived decision to underwrite the policy for the vehicle 110.

The decision algorithms can be influenced by a longitudinal cohort analysis 404 from similar YMM, powertrain, standard/optional equipment, and/or trim level analytics of other vehicles 110, which produces a failure-versus-cost actuary table 1002 from the analysis controller 101. This table exercises non-parametric analytics to look for common failures versus mileage versus repair costs versus vehicle valuation deductions. The analysis controller 101 can compare the actuary table 1062 and the output from the weighted valuation modelers 609, 706, along with the VIN-specific historical pedigree data 608 of the vehicle 110 and the repair data 602 associated with the current VIN-specific condition, to calculate a risk involved in underwriting the policy 1001.

For example, this risk can represent the potential of the vehicle 110 being worth less than the warranty policy. The analysis controller 101 can determine whether the VIN-specific data includes any inherent issues 1063 of other vehicles 102 with similar YMM, powertrain, standard/optional equipment, and/or trim levels or any current conditions 1064 which can affect the decision or recommendation made by the analysis controller 101 to underwrite the policy 1001. For example, the analysis controller 101 can examine the data from similar vehicles 110 to determine whether other vehicles 110 (e.g., at least a designated threshold of the other vehicles 110) have the same problems with or failures of onboard systems 201, which can decrease the value of the vehicle 110 being evaluated, even if this vehicle 110 does not yet have these problems or failures with the onboard systems 201 of that vehicle 110. Furthermore, if a policy is underwritten, the analysis controller 101 can provide a maintenance path 1002 to the underwriter to allow the underwriter to monitor activity and valuation trajectories when the data of the vehicle 110 is entered into the system. For example, the analysis controller 101 can notify the underwriter when data of the vehicle 110 changes or is updated within the system and may send updates on the valuation of the vehicle 110 to the underwriter. This can allow the analysis controller 101 to keep the underwriter informed of changes in the value of the vehicle 110, which may impact the financial viability of the policy 1001 on the vehicle 110.

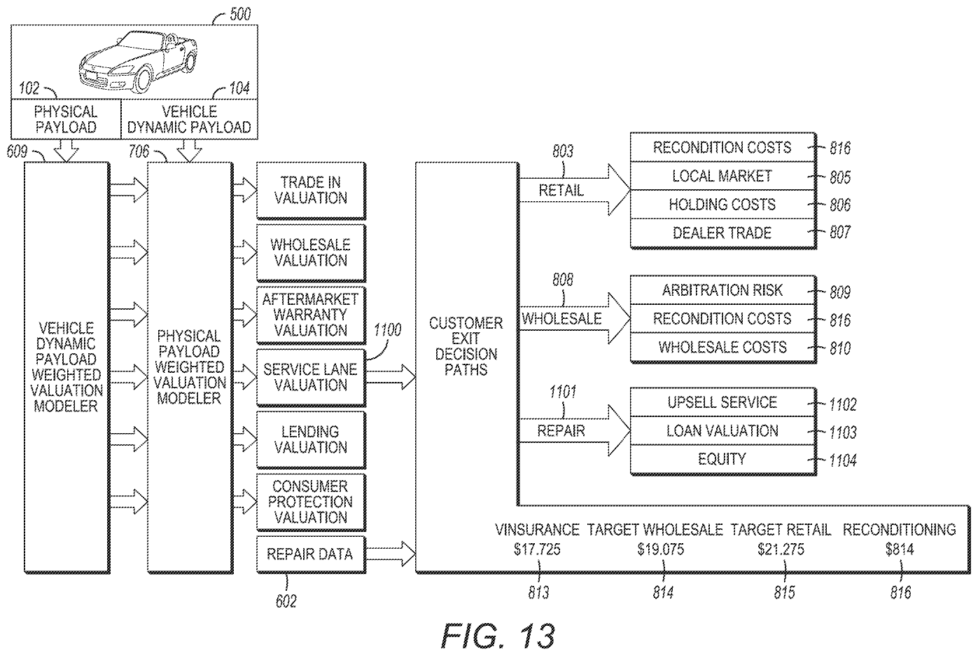

FIG. 13 illustrates operation of the valuation system 106 to gain insight during the disposition decision paths available when evaluating to acquire a vehicle 110 through an automotive service lane environment 1100. This environment can include providing a valuation or recommendation to purchase (or not purchase) or sell (or refuse to sell) a vehicle 110 to a vehicle dealer, sell the vehicle 110 to another consumer, sell the vehicle 110 at an auction, or by trading the vehicle 110 for another vehicle 110. The analysis controller 101 can calculate the valuation and/or provide the recommendation based on several decision factors, such as the reconditioning costs 816 (e.g., the cost to repair and prepare the vehicle 110 for sale, as well as the impact on the repairs on the value of the vehicle 110), local market demand 805 (e.g., the local market interest level determined through non-parametric analysis to produce a weighted value of the vehicle 110 through the analysis controller 101), holding costs 806 (e.g., the calculated depreciation of the vehicle 110 using time against the valuation modelers 609, 706 to algorithmically determine an asset valuation melt rate), a dealer trade value 807 (e.g., the statistical analysis of the prices that dealers have sold vehicles 110 with a similar YMM, powertrain, standard/optional equipment, and/or trim level), and the like. The combination of these decision factors balanced against the VIN-specific valuation of the vehicle 110 may remove subjective evaluation of a trade-in and replace it with scientifically derived values and decision advice.

The analysis controller 101 can evaluate other decision factors, such as the arbitration risk 809, the reconditioning costs 816, wholesale costs 810, which include fees associated with wholesale consignment services, and the like. The analysis controller 101 can examine these costs against the VIN-specific valuation of the vehicle 110 to provide a recommendation that may remove the subjective evaluation of a trade in and replace it with scientifically derived values and decision guidance. In the event that the wholesale decision path 808 is taken, the first guaranteed bid for the vehicle 110 may be set by the valuation 813 provided by the analysis controller 101.

The analysis controller 101 can evaluate several decision factors for calculating values of the vehicle 110 for repair. These factors may include an upsell repair services 1102 that alert a customer of pending issues of a vehicle 110 that the customer may not be aware of, and service can be upsold during purchase of the vehicle 110. Another example of a factor includes a loan valuation 1103 which includes a customer's current loan payment schedule for the vehicle 110 and how exiting the customer from the vehicle 110 into a new vehicle 110 will affect the monthly loan payments versus the total repair costs of the currently owned vehicle 110. Another factor is an equity amount 1104 which indicates how much equity value the customer owns in the vehicle 110 to calculate the VIN-specific valuation of the vehicle 110 and the impact on the monthly payment made by the customer in the loan valuation 1103 if the vehicle 110 is still financed or the VIN-specific valuation of the vehicle 110 in trade-in decision path 802 is greater. The combination of two or more of these decision factors can be examined and balanced by the analysis controller 101 against the VIN-specific valuation of the vehicle 110 to potentially increase vehicle sales and revenue through the dealership service lane with scientifically derived values and decision advice.

For example, the analysis controller 101 can calculate that the customer would be better served by trading in a currently owned vehicle 110 that the customer still is financing for another vehicle 110 due to the valuation of the currently owned and other vehicles 102, the amount of money still owed by the customer on the currently owed vehicle 110, and the like. The analysis controller 101 can provide a recommendation or difference in the values to the customer or the seller to help these parties understand the different values of the currently owned vehicle 110 and the other vehicle 110.

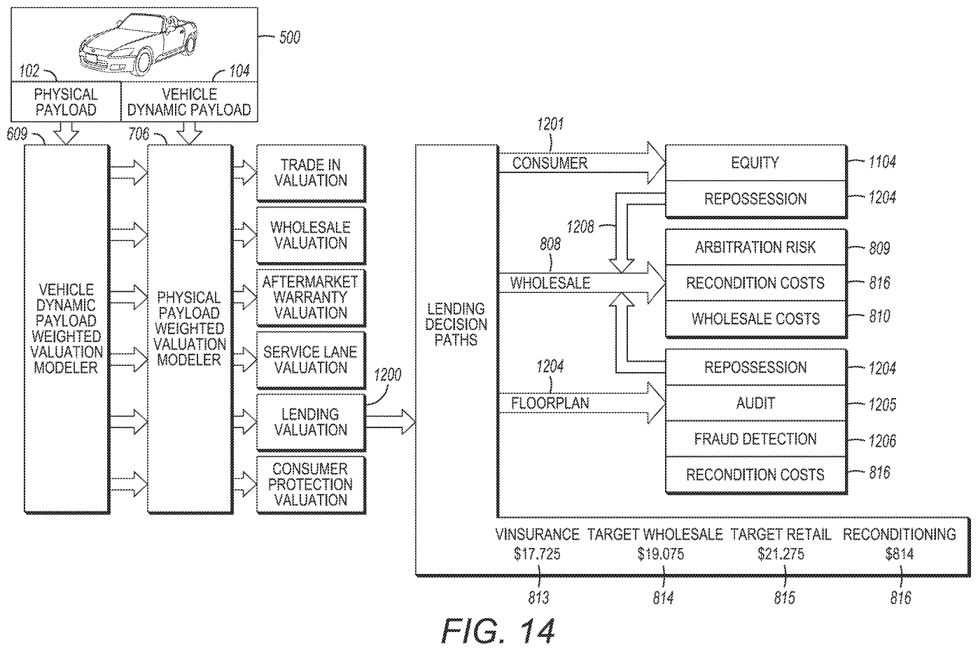

FIG. 14 illustrates operation of the valuation system 106 to gain insight during the lending decision paths available when evaluating whether to extend credit or a loan on a specific VIN of a vehicle 110 via a lending decision path 1200. The analysis controller 101 can evaluate several decision factors to determine whether a seller of a vehicle 110 should be recommended to offer credit (e.g., a loan) to a purchaser of a vehicle 110. These factors may include an equity value 1104 of the vehicle 110 (e.g., the equity valuation of the vehicle 110 compared against the loan value of the vehicle 110 balanced against the VIN-specific valuation of the vehicle 110). Another factor can include a repossession cost 1204 that includes the cost(s) involved in the event that the loan is defaulted and the vehicle 110 has to be repossessed and then resold. The analysis controller 101 can provide the VIN-specific valuation as described above and compare this valuation against the factors described above to determine whether to recommend that the seller offer credit or a loan to the customer. By understanding the wholesale valuation of a repossessed vehicle 110 using the VIN-specific valuations provided by the analysis controller 101, the analysis controller 101 may remove the subjective evaluation of the risk of loss of the loan balance if repossessed and replaces it with scientifically derived values and decision advice.

Additional factors that may be considered for determining a valuation for a vehicle 110 to sell via wholesale lending 808 can include the arbitration risks 809. These risks indicate whether the condition of the vehicle as determined from the modelers 609, 706 such that the vehicle 110 will be or has an increased likelihood of being subjected to arbitration as ruled by the NAAA. Another factor can include reconditioning costs 816 to determine whether repairing the vehicle 110 (e.g., based on the markers that were obtained and/or other information from the tools 701) will either add value at the wholesale market or remove the arbitration risk. Another factor can include wholesale costs 810, which include fees associated with disposing of the vehicle 110 via wholesale consignment services. The combination of these decision factors balanced against the VIN-specific valuation 813, 814, 815, 816 can remove the subjective evaluation of a trade in and replace it with scientifically derived values and decision advice. In the event that the wholesale disposition decision path 808 is taken, the first guaranteed bid for the vehicle can be set by the VINsurance or VIN-specific 813 valuation calculated by the analysis controller 101.

The analysis controller 101 can consider other decision factors when determining whether to recommend or not recommend extending credit or a loan on a vehicle 110. These additional factors can include repossession costs 1204 in the event that the loan is defaulted and the vehicle 110 must be repossessed and resold. Understanding the wholesale valuation of a repossessed vehicle 110 using the VIN-specific valuations described above may remove the subjective evaluation of the risk of loss of the loan balance if repossessed and replaces it with scientifically derived values and decision advice provided by the analysis controller 101. Additional factors considered by the analysis controller 101 can include audit data 1205, which includes audits of collateralized assets by non-authorized personnel performed in accordance with U.S. Pat. No. 7,774,268, fraud detection 1206, which can include collection of VIN-specific data by the analysis controller 101 to fingerprint and/or track the vehicle 110 to ensure that fraudulently identified vehicles 102 for purposes of defrauding lending institutions does not occur, and/or the reconditioning costs 816 to determine whether repairing the vehicle 110 will add value at the wholesale market or remove arbitration risk.

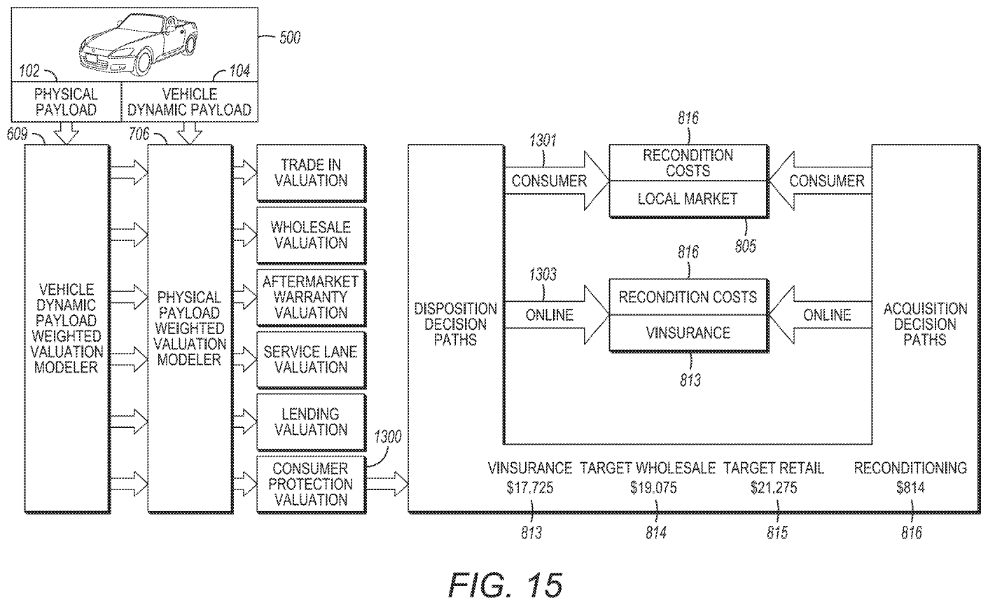

FIG. 15 illustrates operation of the valuation system 106 to gain insight during the consumer's disposition and purchase decision paths available on a specific VIN 1300 of a vehicle 110. The analysis controller 101 can consider several of the same decision factors in the disposition decision path as in the acquisition decision path described above. This can lead to an overall transactional transparency for both parties. For example, the analysis controller 101 can provide an objective, third party valuation of the same vehicle 110 and this valuation can be used by both seller and purchaser in a consumer-to-consumer physical transaction 1301 or a consumer-online transaction 1303 to provide complete transparency of the VIN-specific valuations all parties involved in the potential transaction.

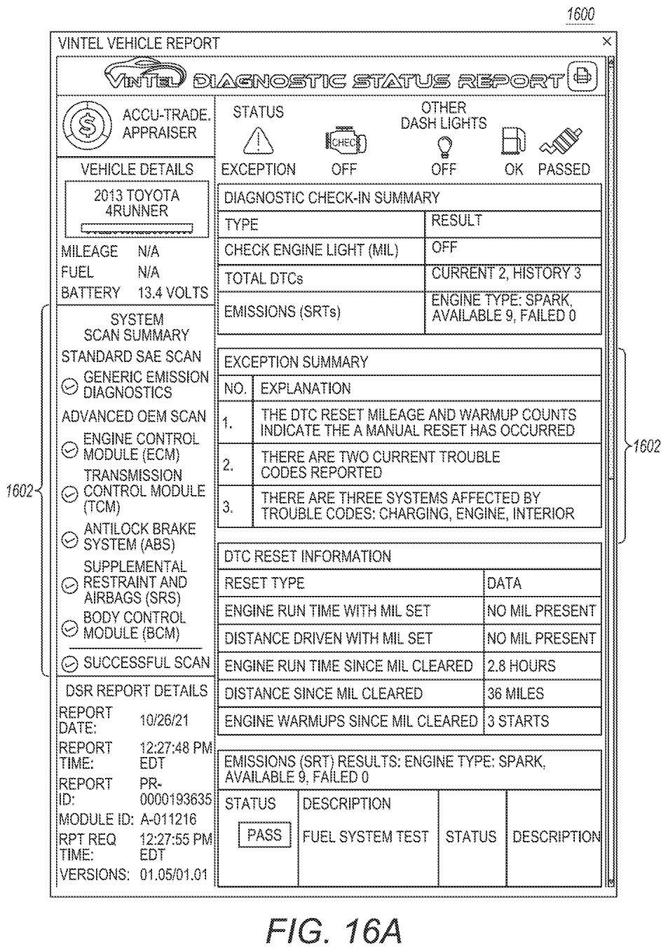

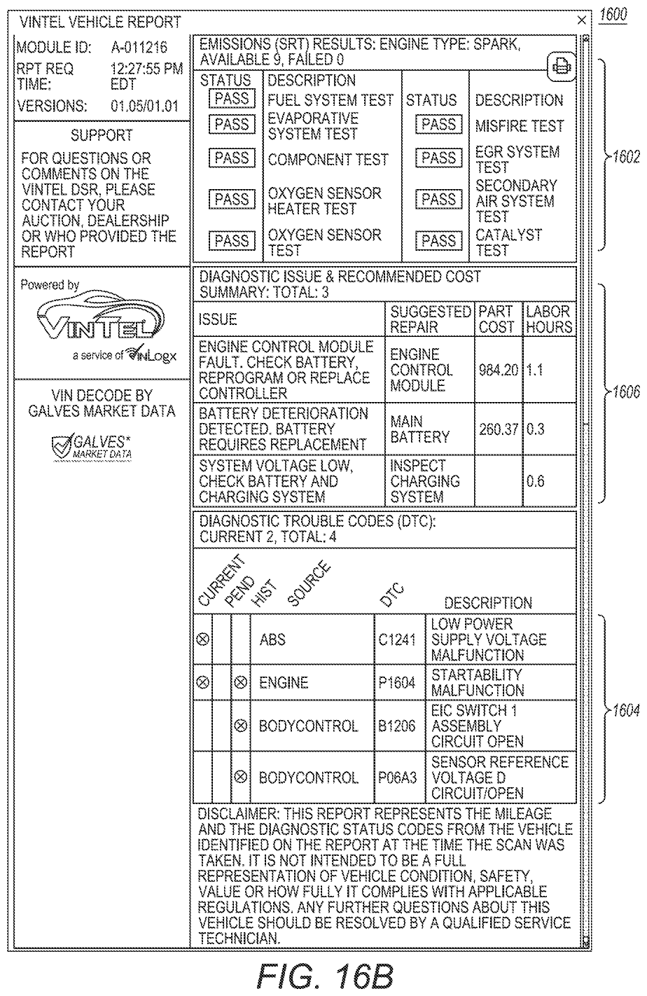

FIGS. 16A and 16B illustrate one example of an output report 1600 that can be generated by the valuation system 106 described herein. The output report 1600 can represent the markers that are extracted and decoded by the valuation system 106, the valuation calculated by the analysis controller 110, and/or other information. This output report 1600 can be displayed on an output device (e.g., the computing device 120 shown in FIG. 1). The decoded markers can indicate results 1602 of various test scans performed by the onboard systems 201 to test the onboard systems 201 or other parts, explanations 1604 of the markers and/or results 1602 of the tests, and the like. The report 1600 also can present a list of recommended repairs 1606 to repair or otherwise address the causes of the results 1602.

As shown, the explanations 1606 can be written in language that is understood by ordinary persons that were not involved in the manufacture, service, or marketing of the vehicle 110. This can assist persons in understanding issues with their vehicles 110 and the potential impact on the valuation of the vehicle 110. The analysis controller 101 optionally can compare the change in valuation if one or more issues associated with the markers are fixed (but taking into consideration the costs of parts and labor to fix the issue(s)) versus not fixing the issue(s) (but saving on the parts and labor costs). If the valuation of the vehicle 110 would improve, the analysis controller 101 can recommend the repair(s) be performed and/or control the disposition system 118 to perform the repairs. Detailed, engineering/manufacturer specific information to assist persons in understanding challenges with their vehicle 110 along with the status of the issues is shown in the explanations 1604.

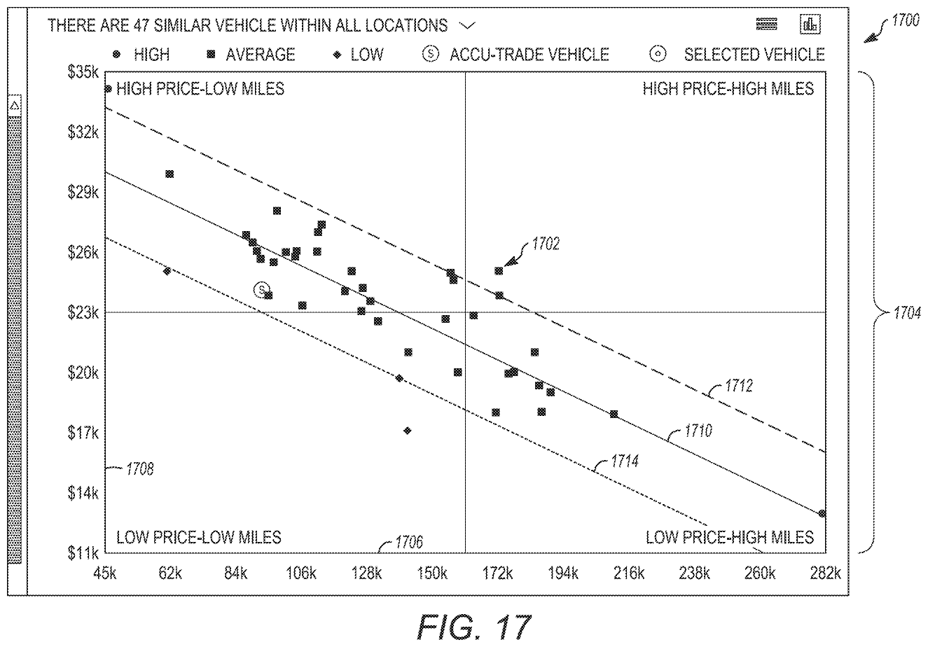

FIG. 17 illustrates operation of the valuation system 106 to monitor trends across valuations of many vehicles 110. The valuation system 106 may be used to calculate values of many vehicles 110 of the same or similar YMM, powertrain, standard/optional equipment, and/or trim levels within a single location or many locations. These locations can be different street addresses, different towns or cities, different counties, different ZIP codes, different states, different countries, and the like. The analysis controller 101 can save valuations of vehicles 110 in the memories 114 and/or 122 and receive an identification of a YMM, powertrain, standard/optional equipment, and/or trim level of a vehicle 110 (e.g., from a user of the computing device 120). The analysis controller 101 can search these valuations and/or perform the valuations based on this input to find the vehicles 110 having the identified YMM, powertrain, standard/optional equipment, and/or trim level.

The analysis controller 101 can generate a report 1700 that displays prices 1702 of vehicles 110 in the same or different locations. The user can restrict which prices 1702 are shown by directing the analysis controller 101 to only show the valuations in certain locations, with certain mileages, with certain body colors, with certain trim levels, etc. The analysis controller 101 can present the prices 1702 on a chart 1704 having a horizontal axis 1706 representative of mileage 603 and a vertical axis 1708 representative of the prices 1702.

The analysis controller 101 can calculate median valuations of the selected YMM, powertrain, standard/optional equipment, and/or trim level across a range of the mileages 603 as described above. That is, the analysis controller 101 can perform one or more of the valuations described above for different mileages and display these median valuations as a median line 1710 in the chart 1704. The analysis controller 101 optionally can display upper and lower boundary lines 1712, 1714, which can represent standard deviation values or other default variances from the median line 1710.

The analysis controller 101 can determine whether any price 1702 is below the valuation calculated by the analysis controller 110 (and therefore, a good deal to purchase) or whether a price 1702 is above the calculated valuation (and potentially a poor purchase). In the illustrated example, the prices 1702A, 1702B, 1702C are indicated by the analysis controller 101 as being below the median line 1710 (and the lower boundary line 1714), indicating that, for the corresponding mileage, the prices 1702A, 1702B, 1702C are lower than the calculated valuations for those vehicles 110 and could be better value purchases than other prices 1702. In one example, the computing device 120 can communicate with the analysis controller 101 to initiate a purchase of a vehicle 110 associated with a selected one of the prices 1702. The computing device 120 and/or analysis controller 101 can then communicate with the owner of the selected vehicle 110 to complete the transaction.

In one example, a system includes a data collection device that may communicate with one or more onboard systems of a first vehicle. The data collection device may receive payload data from the one or more onboard systems that indicate one or more faults with the one or more onboard systems. The system also may include an analysis controller that may obtain the payload data from the data collection device, compare the payload data from the data collection device with other payload data obtained from other vehicles, and calculate a valuation of the first vehicle based on the payload data and comparing the payload data with the other payload data.

The data collection device may receive dynamic payload data as the payload data from the one or more onboard systems. The analysis controller may extract one or more markers from the dynamic payload data indicative of at least one latent fault of the one or more onboard systems. One or more of the data collection device or the analysis controller may receive physical payload data of the payload data from one or more collection tools. The physical payload data may indicate at least one visible fault of the first vehicle.

The analysis controller may compare the payload data of the first vehicle with the other payload data of the other vehicles using a longitudinal cohort analysis. The analysis controller may calculate the valuation of the first vehicle by identifying one or more common clusters of markers within the payload data from the first vehicle and within the other payload data from the other vehicles and weighing other valuations of the other vehicles based on the one or more common clusters. The analysis controller may extract one or more markers from the payload data indicative of the one or more faults and may determine one or more repair costs to correct the one or more faults and may calculate the valuation based also on the one or more repair costs. The analysis controller may control a disposition system to one or more of automatically repair the one or more faults of the first vehicle or move the first vehicle to a location for a disposition of the first vehicle responsive to the valuation being calculated.

In another example, a method includes communicating with one or more onboard systems of a first vehicle to receive payload data from the one or more onboard systems. The payload data may indicate one or more faults with the one or more onboard systems. The method also may include comparing the payload data from the data collection device with other payload data obtained from other vehicles and calculating a valuation of the first vehicle based on the payload data and comparing the payload data with the other payload data.

The payload data may be received as dynamic payload data from the one or more onboard systems. The method also may include extracting one or more markers from the dynamic payload data indicative of at least one latent fault of the one or more onboard systems. The payload data may include physical payload data received from one or more collection tools. The physical payload data may indicate at least one visible fault of the first vehicle.

The payload data of the first vehicle may be compared with the other payload data of the other vehicles using longitudinal cohort analysis. The valuation of the first vehicle may be calculated by identifying one or more common clusters of markers within the payload data from the first vehicle and within the other payload data from the other vehicles, and by weighing other valuations of the other vehicles based on the one or more common clusters.

The method also may include extracting one or more markers from the payload data indicative of the one or more faults and determining one or more repair costs to correct the one or more faults. The valuation may be calculated based also on the one or more repair costs. The method also may include one or more of automatically repairing the one or more faults of the first vehicle or moving the first vehicle to a location for a disposition of the first vehicle responsive to the valuation being calculated.

In another example, another system may include a data collection device that may communicate with one or more onboard systems of a first vehicle. The data collection device may receive payload data from the one or more onboard systems that indicate one or more faults with the one or more onboard systems. The system also may include an analysis controller that may obtain the payload data from the data collection device, extract one or more markers from the dynamic payload data indicative of at least one latent fault of the one or more onboard systems, compare the payload data from the data collection device with other payload data obtained from other vehicles, and calculate a valuation of the first vehicle based on the payload data and comparing the payload data with the other payload data using a longitudinal cohort analysis.

One or more of the data collection device or the analysis controller may receive physical payload data of the payload data from one or more collection tools. The physical payload data may indicate at least one visible fault of the first vehicle. The analysis controller may calculate the valuation of the first vehicle by identifying one or more common clusters of markers within the payload data from the first vehicle and within the other payload data from the other vehicles, and by weighing other valuations of the other vehicles based on the one or more common clusters.

The analysis controller may extract one or more markers from the payload data indicative of the one or more faults and may determine one or more repair costs to correct the one or more faults and calculate the valuation based also on the one or more repair costs. The analysis controller may control a disposition system to one or more of automatically repair the one or more faults of the first vehicle or move the first vehicle to a location for a disposition of the first vehicle responsive to the valuation being calculated. The analysis controller may translate one or more of the markers and display a translation of the one or more markers.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

As used herein, an element or step recited in the singular and proceeded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following clauses, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 101(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein define the parameters of the inventive subject matter, they are exemplary embodiments. Other embodiments will be apparent to one of ordinary skill in the art upon reviewing the above description. The scope of the inventive subject matter should, therefore, be determined with reference to the appended claims, along with the full scope of equivalents to which such clauses are entitled.

This written description uses examples to disclose several embodiments of the inventive subject matter, including the best mode, and to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

A reference herein to a patent document or any other matter identified as prior art, is not to be taken as an admission that the document or other matter was known or that the information it contains was part of the common general knowledge as at the priority date of any of the claims.

What is claimed is:

1. A system comprising:
a data collection device configured to communicate with one or more onboard systems of a first vehicle, the data collection device configured to receive payload data from the one or more onboard systems that indicate one or more faults with the one or more onboard systems; and
an analysis controller configured to obtain the payload data from the data collection device, compare the payload data from the data collection device with other payload data obtained from other vehicles, and calculate a valuation of the first vehicle based on the payload data and comparing the payload data with the other payload data.

2. The system of claim 1, wherein the data collection device is configured to receive dynamic payload data as the payload data from the one or more onboard systems, and the analysis controller is configured to extract one or more markers from the dynamic payload data indicative of at least one latent fault of the one or more onboard systems.

3. The system of claim 1, wherein one or more of the data collection device or the analysis controller is configured to receive physical payload data of the payload data from one or more collection tools, the physical payload data indicative of at least one visible fault of the first vehicle.

4. The system of claim 1, wherein the analysis controller is configured to compare the payload data of the first vehicle with the other payload data of the other vehicles using a longitudinal cohort analysis.

5. The system of claim 1, wherein the analysis controller is configured to calculate the valuation of the first vehicle by identifying one or more common clusters of markers within the payload data from the first vehicle and within the other payload data from the other vehicles, and weighing other valuations of the other vehicles based on the one or more common clusters.

6. The system of claim 1, wherein the analysis controller is configured to extract one or more markers from the payload data indicative of the one or more faults, the analysis controller configured to determine one or more repair costs to correct the one or more faults and to calculate the valuation based also on the one or more repair costs.

7. The system of claim 1, wherein the analysis controller is configured to control a disposition system to one or more of automatically repair the one or more faults of the first vehicle or move the first vehicle to a location for a disposition of the first vehicle responsive to the valuation being calculated.

8. A method comprising:
communicating with one or more onboard systems of a first vehicle to receive payload data from the one or more onboard systems, the payload data indicative of one or more faults with the one or more onboard systems;
comparing the payload data from the data collection device with other payload data obtained from other vehicles; and
calculating a valuation of the first vehicle based on the payload data and comparing the payload data with the other payload data.

9. The method of claim 8, wherein the payload data is received as dynamic payload data from the one or more onboard systems, and further comprising:
extracting one or more markers from the dynamic payload data indicative of at least one latent fault of the one or more onboard systems.

10. The method of claim 8, wherein the payload data includes physical payload data received from one or more collection tools, the physical payload data indicative of at least one visible fault of the first vehicle.

11. The method of claim 8, wherein the payload data of the first vehicle is compared with the other payload data of the other vehicles using longitudinal cohort analysis.

12. The method of claim 8, wherein the valuation of the first vehicle is calculated by identifying one or more common clusters of markers within the payload data from the first vehicle and within the other payload data from the other vehicles, and weighing other valuations of the other vehicles based on the one or more common clusters.

13. The method of claim 8, further comprising:
extracting one or more markers from the payload data indicative of the one or more faults; and
determining one or more repair costs to correct the one or more faults, wherein the valuation is calculated based also on the one or more repair costs.

14. The method of claim 8, further comprising one or more of automatically repairing the one or more faults of the first vehicle or moving the first vehicle to a location for a disposition of the first vehicle responsive to the valuation being calculated.

15. A system comprising:
a data collection device configured to communicate with one or more onboard systems of a first vehicle, the data collection device configured to receive payload data from the one or more onboard systems that indicate one or more faults with the one or more onboard systems; and
an analysis controller configured to obtain the payload data from the data collection device, extract one or more markers from the dynamic payload data indicative of at least one latent fault of the one or more onboard systems, compare the payload data from the data collection device with other payload data obtained from other vehicles, and calculate a valuation of the first vehicle based on the payload data and comparing the payload data with the other payload data using a longitudinal cohort analysis.

16. The system of claim 15, wherein one or more of the data collection device or the analysis controller is configured to receive physical payload data of the payload data from one or more collection tools, the physical payload data indicative of at least one visible fault of the first vehicle.

17. The system of claim 15, wherein the analysis controller is configured to calculate the valuation of the first vehicle by identifying one or more common clusters of markers within the payload data from the first vehicle and within the other payload data from the other vehicles, and weighing other valuations of the other vehicles based on the one or more common clusters.

18. The system of claim 15, wherein the analysis controller is configured to extract one or more markers from the payload data indicative of the one or more faults, the analysis controller configured to determine one or more repair costs to correct the one or more faults and to calculate the valuation based also on the one or more repair costs.

19. The system of claim 15, wherein the analysis controller is configured to control a disposition system to one or more of automatically repair the one or more faults of the first vehicle or move the first vehicle to a location for a disposition of the first vehicle responsive to the valuation being calculated.

20. The system of claim 15, wherein the analysis controller is configured to translate one or more of the markers and display a translation of the one or more markers.
